(19) United States
(12) Patent Application Publication
(10) Pub. No.: US 2023/0037728 A1
(43) Pub. Date: Feb. 9, 2023

(54) SOFTWARE, METHODS, AND SYSTEMS FOR BLOCKCHAIN-RECORDED TRANSACTIONS OF REAL-WORLD ASSETS

(71) Applicant: Allele Group LLC, Reno, NV (US)

(72) Inventor: John Caleb MARKS, Sebastopol, CA (US)

(21) Appl. No.: 17/884,522

(22) Filed: Aug. 9, 2022

Related U.S. Application Data
(60) Provisional application No. 63/231,052, filed on Aug. 9, 2021.
(60) Provisional application No. 63/293,631, filed on Dec. 23, 2021.

(51) Int. Cl. G06Q 20/36; G06Q 20/06; H04L 9/00

(52) U.S. Cl. CPC G06Q 20/3678; G06Q 20/065; H04L 9/50

(57) ABSTRACT

A method of offering Unique Identity Asset Marker (UIAM)-linked assets for sale is provided. The method may include receiving, from a verified seller, a request to mint a Parent UIAM token and at least one Child UIAM token; a total number of UIAM-linked assets for sale and financial terms for such sales; a public-facing description of the at UIAM-linked assets for sale; and proprietary data pertaining to the UIAM-linked assets for sale. The method may further include compiling a Parent UIAM, minting a Parent UIAM token, minting one Child UIAM token for each of the UIAM-linked assets for sale, and assigning ownership of the tokens to the verified seller. The method may further include loading the proprietary data into a database, recording a permission structure for accessing the proprietary data in the blockchain, configuring the public-facing description for public viewing, and offering each Child UIAM token and its associated UIAM-linked asset for sale.

This application claims priority to U.S. Provisional patent application Ser. No. 63/231,052, filed on Aug. 9, 2021, and Provisional patent application Ser. No. 63/293,631, filed Dec. 12, 2023, the disclosures of which are hereby incorporated by reference in their entireties.

### TECHNICAL FIELD

This application relates to systems and software that utilize blockchain technology, for example, to support the sale, purchase, and creation of assets in a manner that efficiently enables ownership authentication, access to proprietary asset-related data, and provides an auditable trail; and supports control, tracking, maintenance, and use various forms of personal data, including health and financial data.

In one aspect, this disclosure relates to tokenization, sales of physical assets with genomic fingerprints, corresponding transfers of digital tokens evincing ownership, blockchain recordation(s) thereof, and permissioned access to related proprietary data. Further, portions of this disclosure may specifically relate to systems, algorithms, and software that support and/or enable the tokenization of unique identities (such as, but not limited to, genomic identities) and corresponding data that is owned and verifiable by the asset creator and or holder, which may, in turn enable the sale and purchase of assets in a manner that efficiently enables ownership, authentication, and access to proprietary asset-related data, via a decentralized application utilizing blockchain technology. Additionally, portions of this disclosure may specifically relate to specific protocols that support and/or enable efficient and effective identification verification of both the creator of the physical assets with genomic fingerprints (including, but not limited to, part or all of individual's human genome utilized as a form of digital medical identity); corresponding transfers of digital tokens evincing ownership; blockchain recordation(s) thereof; permissioned access to related proprietary data; and asset transfers.

The teachings of this disclosure may also be applicable to systems and software outside of the genomic asset sales context.

### BACKGROUND

Existing protocols and systems for the purchase, sale, transfer, and tokenization of agricultural, genomic (including products that may alter or account for genomes in a beneficial way), and/or related real world assets—including, but not limited to clones, cuttings, seeds, spores, cell cultures, tissue cultures, microbial agar, fungal sporulates, and/or the like—are inefficient and leave much to be desired.

Currently, a buyer may select and purchase such assets at an e-commerce website, brick-and-mortar store, and/or the like. However, existing transaction protocols typically do not, or cannot, offer authentication of asset ownership; chain of custody of asset ownership; authentication that the physical asset is what it purports to be; access to proprietary information relating to the asset, including for example, genetic code, agronomy instructions, and/or the like; maintenance of legal documentation governing the asset, including for example, IP licenses, regulatory documents, contractual limitations on transfer and/or the like; verifiable safety information; verifiable lineage information; reliable consumer experience data; and/or protocols to document ownership and downstream transactions relating to offspring of transferred physical assets. Moreover, to the extent that such existing transaction protocols provide for some of these offerings, they may incur high transaction costs and high data maintenance costs.

For example, in the cannabis industry, a grower may seek to purchase clones of particular cultivar (strain). The prospective buyer may, in many instances, lack a personal trust relationship with the prospective seller, especially when a purchase takes place via e-commerce. Accordingly, the prospective buyer may be, for example, at risk of paying money to a “seller” who does not actually own or possess the asset, paying money to seller who has improperly obtained the asset, receiving clones that are not what the buyer expects or paid for, and/or the like. Conversely, a prospective seller may be unable to obtain sufficient assurances that the prospective buyer will refrain from growing and/or re-selling offspring clones without authorization and proper renumeration, that the prospective buyer has appropriate licensure or regulatory approvals, and/or the like.

### SUMMARY

The present disclosure provides a description of algorithmic methods, apparatuses, systems, and software to address the perceived problems described above—as well as provide efficient solutions for the recordation, maintenance, and tracking of both confidential and non-confidential data—related to real-world assets, digital assets, individuals, and/or corporate entities.

In some embodiments, at least one non-transitory computer readable storage medium storing a computer program is provided. When executed by a computer, for example, on a server, smart phone, PC, or tablet, the computer program may perform the algorithm embodiments described herein, or a relevant portion thereof. In some embodiments, a decentralized network of nodes may be provided and/or utilized to perform, in part or in whole, the algorithm embodiments described herein, or a relevant portion thereof. A decentralized network of nodes may, for example, execute smart contracts, establish Ricardian contracts, execute other application functions, act as a data repository, interact with an interplanetary file system and/or the decentralized Web 3.0 database, and/or interact with or execute other software architectures. It is to be understood that the descriptions herein are exemplary and explanatory only and are not restrictive of the inventive concepts disclosed.

In one embodiment, a method of offering at least one Unique Identity Asset Marker (UIAM)-linked asset for sale is provided. The method may include receiving, from a verified seller with a UIAM minter account, a request to mint a Parent UIAM token and at least one Child UIAM token; a total number of the at least one UIAM-linked asset for sale and financial terms for sale of each of the at least one UIAM-linked asset for sale; a public-facing description of the at least one UIAM-linked asset for sale; and proprietary data pertaining to the at least one UIAM-linked asset for sale. The method may further include compiling a Parent UIAM file based on verified seller input, minting a Parent UIAM token on a first blockchain, minting one Child UIAM token on the first blockchain for each of the total number of the at least one UIAM-linked asset for sale, and assigning ownership of the Parent UIAM token and each Child UIAM token to the verified seller. The method may further include loading the proprietary data into a database, recording a permission structure for accessing the proprietary data in the first blockchain, configuring the public facing description for public viewing, and offering each Child UIAM token and its associated UIAM-linked asset for sale.

The method may further include receiving utility tokens and/or stable bank coins from the verified seller as compensation for UIAM token minting.

The at least one UIAM-linked asset for sale may be a genomic asset. The step of receiving proprietary data pertaining to the at least one UIAM-linked asset for sale may further include receiving a gene sequence file of the genomic asset.

The genomic asset may include at least one of a cannabis plant, seed, flower, and a derivative thereof. The step of receiving the public-facing description of the at least one UIAM-linked asset for sale may further include receiving a cultivar name from the verified seller.

The step of receiving proprietary data pertaining to the at least one UIAM-linked asset for sale may further include receiving phenotypical trait data relating to a particular environmental condition.

The step of receiving the public-facing description of the at least one UIAM-linked asset for sale may further include receiving a gene sequence file of the genomic asset.

The method may further include receiving, from the verified seller, Ricardian Contract terms governing a contemplated sale of the at least one UIAM-linked asset.

The step of receiving the public-facing description of the at least one UIAM-linked asset for sale may further include receiving a description of downstream breeding rights governing the genomic asset. The method may further include receiving, from the verified seller, Ricardian Contract terms governing a contemplated sale of the at least one UIAM-linked asset, wherein at least a portion of the Ricardian Contract terms address downstream breeding rights

The step of configuring the public facing description for public viewing may further include loading at least a portion of the public facing description into an InterPlanetary File System and/or publishing at least a portion of the public facing description as an Oracle on the first blockchain.

The step of loading the proprietary data into a database may further include loading at least a portion of the proprietary data into an InterPlanetary File System.

The step of receiving, from the verified seller, a total number of the at least one UIAM-linked asset for sale and financial terms for sale of each of the at least one UIAM-linked asset for sale may include providing the verified seller with selectable smart contract options and receiving selections of smart contract options from the verified seller.

The step of receiving, from the verified seller, the public-facing description of the at least one UIAM-linked asset for sale may include receiving directly uploaded data files from the seller, receiving an Internet address, and/or receiving references to a UIAM token.

The step of receiving, from the verified seller, proprietary data pertaining to the at least one UIAM-linked asset for sale may include receiving directly uploaded data files from the seller, receiving an Internet address, and/or receiving references to a UIAM token.

The method may further include receiving financial account data and identifying information from a prospective seller, and verifying the data provided by the prospective seller. If the data verification is successful, the method may further include whitelisting a digital wallet of the prospective seller via smart contract execution on the first blockchain and generating a UIAM minter account for the seller. In other embodiments, if the data verification is successful, the method may further include, generating a UIAM minter account for the verified seller, recording the verified seller identity and minter status in the first blockchain, and providing a UIAM minter token and an identity token to the verified seller.

In another embodiment, a method of establishing collaborative breeding parameters is provided. The method may include providing a first user and providing a second user. The first user may own a first UIAM (unique identity asset marker) token corresponding to a first genomic asset and the second user may own a second UIAM token corresponding to a second genomic asset. The method may further include providing the first UIAM token, providing the second UIAM token, and receiving a Ricardian contract with terms governing ownership rights for offspring of the first and second genomic assets. The Ricardian contract may be digitally executed and may be published on at least one blockchain. The method may further include minting a third UIAM token corresponding to a first offspring of the first and second genomic assets to the at least one blockchain. The third UIAM token may reflect the terms of the Ricardian contract and may evidence lineage of both the first UIAM token and the second UIAM token.

The step of digitally executing the Ricardian contract may further include receiving digital signatures from the first user and the second user. The step of publishing the Ricardian contract on the at least one blockchain may further includes recording a digital wallet address of the first user and a digital wallet address of the second user on the at least one blockchain.

The step of minting the third UIAM token to the at least one blockchain may further include minting the third UIAM token to a first blockchain of the at least one blockchain. The step of publishing the Ricardian contract on at least one blockchain may further include publishing the Ricardian contract on a second blockchain of the at least one blockchain.

The step of providing the first UIAM token may further include providing the first UIAM token on the first blockchain. The step of providing the second UIAM token may further include providing the second UIAM token on the first blockchain.

The first blockchain may be a Polygon blockchain. The second blockchain may be a Komodo blockchain and/or an Alysides blockchain.

The step of receiving the Ricardian contract with terms governing ownership rights may further include receiving at least one transaction hash from the first blockchain within the Ricardian contract.

The first UIAM token may be configured to provide access permissions to a first proprietary data set pertaining to the first genomic asset. The second UIAM token may be configured to provide access permissions to a second proprietary data set pertaining to second first genomic asset. The third UIAM token may be configured to provide access permissions to third proprietary data set pertaining to the first offspring. The third UIAM token may be further configured to provide access permissions to at least a portion of the first proprietary data set and at least a portion of the second proprietary data set.

The first, second, and third proprietary data sets may be stored in an Interplanetary File System.

The first proprietary data set may contain at least a gene sequence file of the first genomic asset. The second proprietary data set may contain at least a gene sequence file of the second genomic asset. The third proprietary data set may contain at least a gene sequence file of the first offspring.

The first UIAM token may reflect a genomic fingerprint of the first genomic asset. The second UIAM token may reflect a genomic fingerprint of the second genomic asset.

The step of receiving a Ricardian contract may further include receiving contract terms that assign offspring ownership rights to the first user and the second user based at least in part on whether the first genomic asset or the second genomic asset provided a desirable offspring trait.

The first UIAM token may be linked to first public-facing data pertaining to the first genomic asset. The second UIAM token may be linked to second public-facing data pertaining to the second genomic asset.

The first public-facing data and the second public-facing data may be stored as Oracles on the at least one blockchain.

The third UIAM token may be configured to link to the first public-facing data and the second public-facing data.

The third UIAM token may be linked to third public-facing data pertaining to the first offspring. The third public-facing data may stored as Oracles on the at least one blockchain.

### BRIEF DESCRIPTION OF THE DRAWINGS

The accompanying drawings, which are incorporated into and constitute a part of this specification, illustrate several embodiments and aspects of the apparatuses and methods described herein and, together with the description, serve to explain the principles of the invention.

FIGS. 1A-1C are a high-level diagrams illustrating exemplary UIAM systems in accordance with exemplary embodiments.

FIG. 2 is a block diagram illustrating an exemplary computing device and/or mobile device of FIGS. 1A-1C, in accordance with exemplary embodiments.

FIGS. 3A-3D are flow charts of methods of purchasing a UIAM-linked asset, in accordance with exemplary embodiments.

FIG. 4 is a flow chart of a method of UIAM minting, in accordance with exemplary embodiments.

FIG. 5 is a flow chart of a method of generating UIAM offspring, in accordance with exemplary embodiments.

FIG. 6 is a flow chart of a method of UIAM-linked asset delivery, in accordance with exemplary embodiments.

FIG. 7 is a flow chart of a method of UIAM purchaser account creation, in accordance with exemplary embodiments.

FIGS. 8A and 8B are flow charts of methods of UIAM minter account creation, in accordance with exemplary embodiments.

FIG. 9 is a flow chart a method of chain of custody tracking using the UIAM framework, in accordance with exemplary embodiments.

### DETAILED DESCRIPTION

A Unique Identity Asset Marker (UIAM) token may be understood as a nonfungible digital token (NFT) that, in various embodiments, may be indicative of ownership a particular unit of a linked physical (or non-physical) asset, may be indicative an entity's (e.g., individual or corporate) identity, may be indicative of an entity's credentials (e.g., licenses possessed, affiliation with a particular group), may reflect that the token holder is authorized to access certain data, and/or the like. For example, UIAMs may be tokenized real world assets, commodities, synthetic commodities, social benefit algorithms, and/or the like.

In preferred embodiments, a user's ownership a UIAM token may be evidenced by a user's possession of such token(s) by the user's digital wallet (or in alternative embodiments, a user's digital vault). As is known in the art, the user may possess a private cryptographic key the provides secure access to her digital wallet and may evince ownership to the wallet and its contents. It is contemplated that, ownership and transfers of UIAM tokens and corresponding rights, data, and/or assets, may be permanently recorded on public and/or private blockchains, and/or via maintained on other digital ledgers. Because UIAM transactions may, in the typical instance, be maintained via public blockchain protocols, such as, for example, Oracles, stored on the block chain, UIAMs may be readily auditable. As is known in the art, an Oracle may be understood as a machine-readable snippet of data publicly published to a blockchain with a specific time stamp in a manner that permits the data to be readily queried later.

UIAM tokens may be understood to have a hierarchical structure. A Parent UIAM (Master UIAM) may be understood to (at least initially) own its Child UIAM(s) (Fractional UIAM). Child UIAMs are generated from and inherently, permanently related to their respective (original) Parent UIAMs. A permanent digital record of such parent/child UIAM relationships may be permanently maintained on public and/or private blockchains, and/or via maintained on digital ledgers.

It is further contemplated that a UIAM may provide its owner with permissioned access to proprietary digital data. In some embodiments, UIAM-linked proprietary data may be stored in a centralized or decentralized database, for example, a decentralized InterPlantery File System, as described in more detail below. Corresponding UIAM token ownership may authorize viewing and/or modification access to such proprietary data. Further, permissioned access to the UIAM-linked proprietary data may be similarly documented in and/or enabled by transactions published in a public blockchain, a private blockchain, and/or a decentralized digital ledger.

Additionally or alternatively, UIAM-linked proprietary data may, be published to the blockchain, using, for example, the ERC 998, ERC 1155, and/or ERC 721 token standard on the polygon blockchain. This may, in some embodiments, render the use of a decentralized or centralized database unnecessary. Such proprietary data may be understood to be published in an encrypted manner on a public (and/or private) blockchain. Holders of digital wallets in possession of corresponding UIAM tokens may be able to view and/or modify such proprietary data as appropriate.

It is further contemplated that each UIAM token may be linked to public-facing data. Such public-facing data may include a non-confidential description of the UIAM token, and any corresponding asset, data, and related limitations thereon. In some embodiments, the blockchain-based, auditable transaction history of each UIAM token may be considered public-facing data. It is contemplated that in some embodiments, all or substantially all UIAM public-facing data may be stored as Oracles on, for example, a public blockchain. However, this disclosure is not so limited: Public-facing data for a UIAM token may additionally or alternatively be stored on a private blockchain, in decentralized database (e.g., IFPS), in a centralized database (e.g., cloud storage), and/or the like.

UIAM tokens may further include smart contract code governing their use, including that of their progeny. For example, smart contract code may serve ensure that certain requisite transactions take place (e.g., effectuating payments from a buyer to a seller on a time schedule) and that prohibited transactions do not occur (e.g., minting Child UIAM tokens for the offspring of a genomic asset for which breeding rights were not granted).

In certain embodiments, UIAM tokens may be linked to Ricardian Contracts. Ricardian Contracts are legally-binding digital contracts that are cryptographically maintained, digitally signed by the contracting parties, verifiable using a blockchain, and is readable by both machines (in code) and humans (in corresponding text form). Vleppo (Vleppo.com) provides a suitable technological framework for the execution and management of Ricardian Contracts. Linking a Ricardian Contract to UIAM tokens efficiently enables management of the UIAM tokens, associated real world assets, associated proprietary data, downstream child UIAM tokens (and their associated real work assets and data) and/or the like via legally-binding and legally enforceable contract terms bound to UIAM tokens. Stated another way contractual obligations may be irrevocably bound to a UIAM token and, when appropriate, its UIAM progeny.

In one embodiment, Ricardian Contracts may be maintained on blockchain separate from the blockchain upon which the core UIAM transactions are maintained. In this manner, an executed Ricardian Contract may be considered an off-chain transaction with reference to UIAM minting transactions, buy/sell transactions, and/or the like. However, a Ricardian Contract and a UIAM transaction may be permanently and verifiably bound by including identifying data references—preferably the transaction hash from the corresponding UIAM token transaction—within the Ricardian Contract itself. Additionally, the wallet address of each contracting party may be expected to link to both the Ricardian Contract and the UIAM token transaction on their respective blockchains. To facilitate transparency, it is contemplated that a system user may make their wallet address public on their profile to enable others to ascertain whether certain UIAM tokens are governed by Ricardian Contracts—but without, in most instances, revealing the potentially confidential terms of the Ricardian Contract. In certain preferred embodiments, the UIAM tokens may be minted to the Polygon blockchain (e.g., by UIAM Application entity 120, discussed below), but the Ricardian Contracts may be effectuated on the Alysides Blockchain (a fork of the Komodo Blockchain). The Komodo blockchain is specific to Ricardian contracts. While Komodo is a public blockchain, Ricardian Contract terms on Komodo (and its forks) are not publicly viewable and require a private key to decrypt and view such confidential information.

In other embodiments, Ricardian Contracts may be maintained on the same blockchain upon which the core UIAM transactions are published and maintained.

In the UIAM asset context, a Parent UIAM may be broadly understood as a digital token that describes and enables the sale of a batch of physical and/or non-physical asset units, and may further enable control and/or revision of linked proprietary data. A Parent UIAM token (including its digital, genomic, and/or medical identity, and its creator features) may permit a user to mint UIAM Child tokens. Each UIAM Child token may represent a number of real world items (and/or digital items) that may be linked to its Parent UIAM and the other minted Child UIAM tokens via a particular genetic make-up, a particular formula, a specific set of environmental conditions, and/or the like.

In typical applications of UIAM technology in the asset context, each buy/sell transaction may transfer a Child UIAM token(s), a unit(s) of Child UIAM-linked physical asset, and access to UIAM-linked proprietary data to the buyer—and provide appropriate renumeration to the seller. Each such transaction may be recorded in a public (and unalterable) blockchain, in a private (unalterable) blockchain, and/or in another decentralized digital ledger—and accordingly may establish a permanent, reliable, chain of ownership of the Child UIAM token and linked components.

For example, a genomic sequence file, genetic fingerprint, and/or other genetic data corresponding to the UIAM-linked physical asset may be included as proprietary data. Copies of confidential documentation, for example, that was generally described or referenced in the public-facing description, may also be included as proprietary data. As appropriate, proprietary data may further include botanical descriptions, other data-based identification of the physical asset, methods of growing and/or breeding, other agronomy data or methods, material transfer agreements, regulatory documentation, contractual documentation, IP license documentation, logos, NFT artwork, unpublished plant varietal and/or utility patent applications, and/or the like. In some embodiments, UIAM-linked proprietary data may also understood include or provide links to publicly available or otherwise non-proprietary data pertaining to the UIAM, such as issued patents, published patent applications, and/or published research.

In some alternative embodiments, the UIAM-linked physical asset may be omitted from the transaction and only UIAM-linked proprietary data access may accompany the Child UIAM token in the transaction. In yet other alternative embodiments, the UIAM-linked proprietary data may be omitted from the transaction and only UIAM-linked physical asset may accompany the Child UIAM token in the transaction.

In the UIAM personal identity context, an identity Parent UIAM may be broadly understood as a digital token that serves as an individual's financial and/or medical identity. It is contemplated that an individual may own a personal financial identity Parent UIAM and/or a personal medical identity Parent UIAM. Additionally, it is contemplated that, in some embodiments, an individual may own a single personal identity UIAM that comprises aspects of their personal identity and their medical identity. In another embodiment, an individual's personal financial identity Parent UIAM can serve as the highest level identity Parent UIAM, and the person's personal medical identity Parent UIAM may be a hierarchical child of the personal financial identity Parent UIAM—or vice versa. Further, although financial identities are substantially discussed herein with respect to individual humans, corporate identity Parent UIAMs that represent the financial identity of a corporate entity are also specifically contemplated.

Ultimately, a UIAM framework may incorporate and integrate both asset-based UIAMs and identity UIAMs. It is contemplated that utilization of a UIAM framework may enable controlled, secure, and efficient sharing of information; tokenization of assets; transfer of assets; collaborative uses of financial, physical, and/or digital assets (e.g., liquidity pools discussed in more detail below); collaborative uses of medical and/or physiological data; reliable identification of individuals and entities; and/or the like in unique and novel ways that may improve commerce, improve the provision of medical and wellness care for individuals and/or at large, support efficient and economical research and product development, and/or the like.

For example, as discussed in further detail below, utilization of the UIAM framework may enable the provision of diagnostic insight into the expression of a genotype as a phenotype in view of environmental conditions or a patient, patient group, and/or genomic assets.

In another example, UIAM tokens may be provided as rewards or payment to another Parent UIAM.

It is contemplated that the UIAM framework may provide a secure, transparent, and substantially trustless system for managing physical assets—including genomic assets and their progeny, digital assets, sensitive data, regulatory compliance, IP license/transaction compliance, and/or the like. By leveraging Blockchain technology, such a framework can efficiently and effectively support a wide array of complex and hierarchical transactions to, for example, improve the flow of commerce, enable breeding collaborations, provide reliable supply chain information, improve the practice of medicine, promote improvements in human health, and/or the like.

### Exemplary UIAM System Structure:

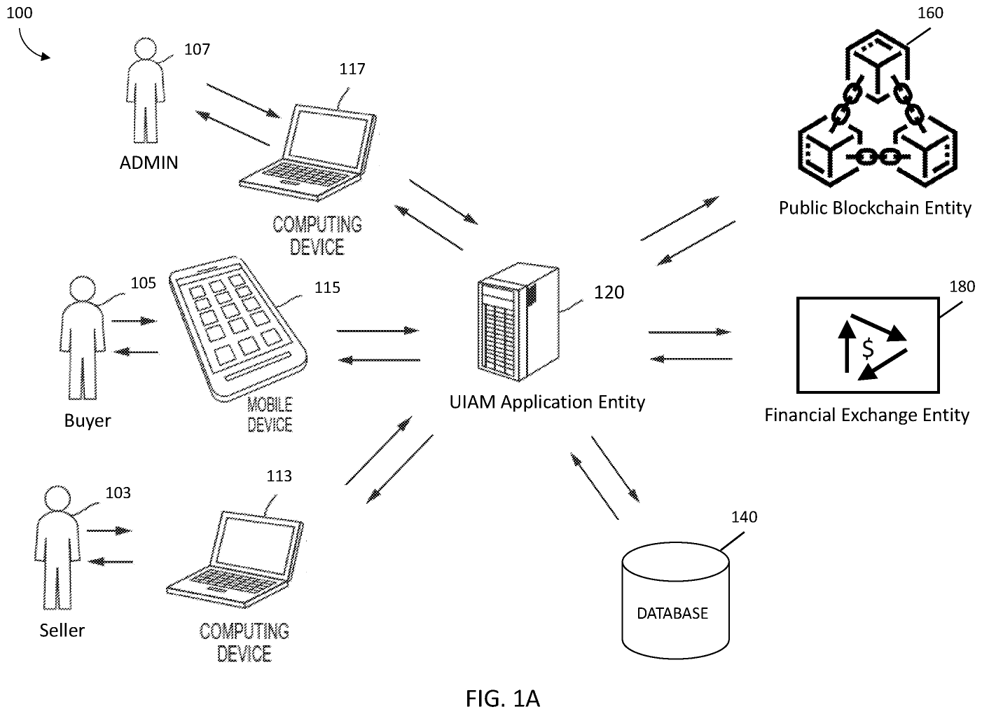

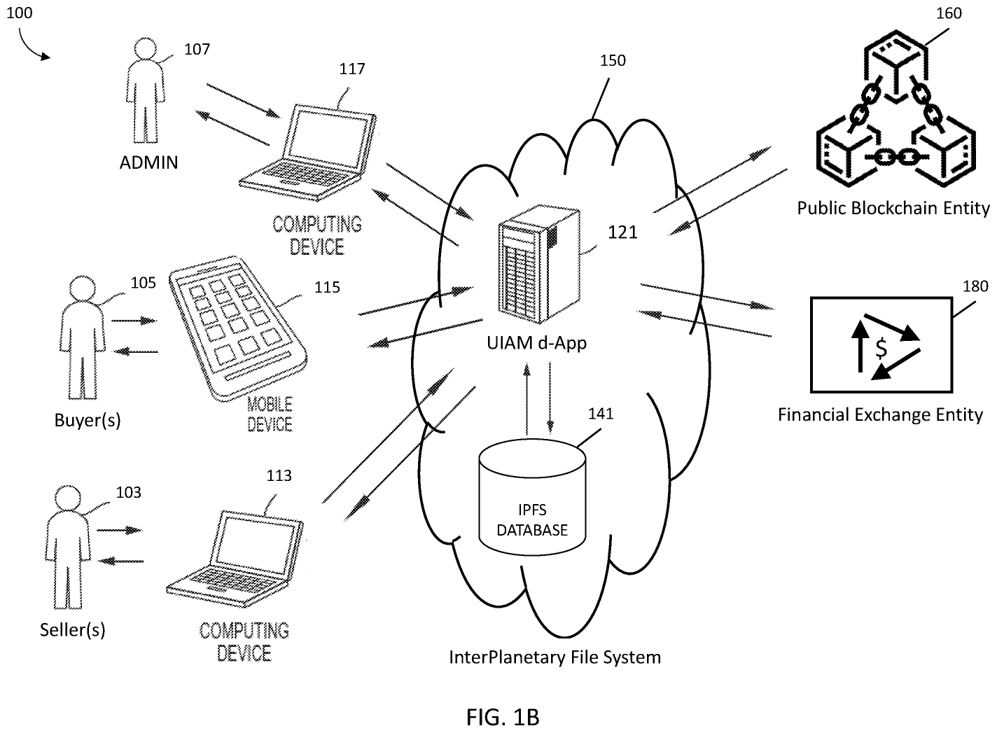

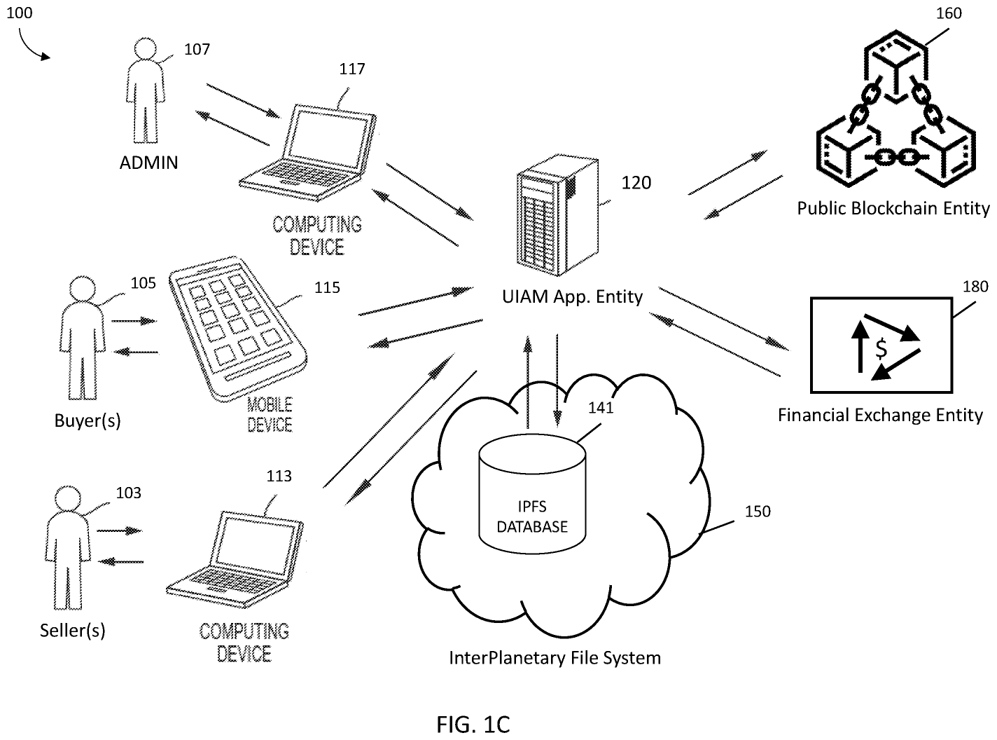

FIGS. 1A-1C illustrate exemplary embodiments of Unique Identity Asset Marker (“UIAM”) system 100, in accordance with embodiments of this disclosure. While the structure of system 100 is substantially discussed with reference to the UIAM asset context for illustrative purposes, one of ordinary skill in the art would readily understand how such system would also support the functionality required for the UIAM personal/corporate identity context, health contexts, other contexts, and/or combined contexts.

System 100 may include one or more buyers 105. Buyer(s) 105 may use mobile device 115 running mobile application software and/or a web interface to interact with other components and users of system 100. In preferred embodiments, mobile device 115 may be a smart phone running, for example, Apple® OS, Android®, or the like. Mobile device 115, discussed in more detail below, however, is not so limited: It may be any type of mobile computing device suitable for performing the functions and algorithms disclosed herein such a smart watch, laptop computer, notebook computer, tablet computer, etc. Mobile device 115 may be connected to one or more communications network (not identified with element numbers, but represented with bi-directional arrows in FIGS. 1A, 1B, and 1C), and may connect to a UIAM Application entity 120 therethrough.

As would be appreciated by a person of ordinary skill in the art, the term “entity” as used herein may refer to an identifiable operational structure, including, but not limited to a centralized or decentralized software structure, and which may or may not be correspond or be associated with a legal (corporate) entity.

Additionally or alternatively, one or more buyers 105 may use a computing device running application software and/or a web interface to interact with other components and users in system 100 instead of a mobile device 115. A computing device may be substantially the same as mobile device 115, but it is anticipated to be a laptop or desktop computer in many embodiments. Computing device may be connected to a communications network(s), and may connect to UIAM Application Entity 120 therethrough.

It is contemplated that system 100 may concurrently and/or sequentially provide service to multiple buyers 105 interfacing with multiple mobile devices 115 and/or computing devices, respectively.

The communications network(s) may be one or more of any type of communications network suitable for performing the functions disclosed herein as will be apparent to persons having skill in the relevant art. It may include one or more communications technologies, including, but not limited to 3G, LTE, 4G, 5G, WiMax, the Internet, and/or the like.

System 100 may include one or more sellers 103 who may provide a UIAM offering. Seller 103 may use computing device 113 running application software and/or a web interface to interact with other components and users in system 100. Computing device 113 may be substantially the same as a buyer's 105 computing device (discussed above, but not shown in drawings) or alternatively may be substantially the same as mobile device 115. Computing device 113 may be connected to a communications network(s), and may connect to UIAM Application Entity 120 therethrough. It is contemplated that system 100 may concurrently provide service to multiple sellers 103 concurrently to, for example, facilitate multiple simultaneous UIAM sales and/or other transactions.

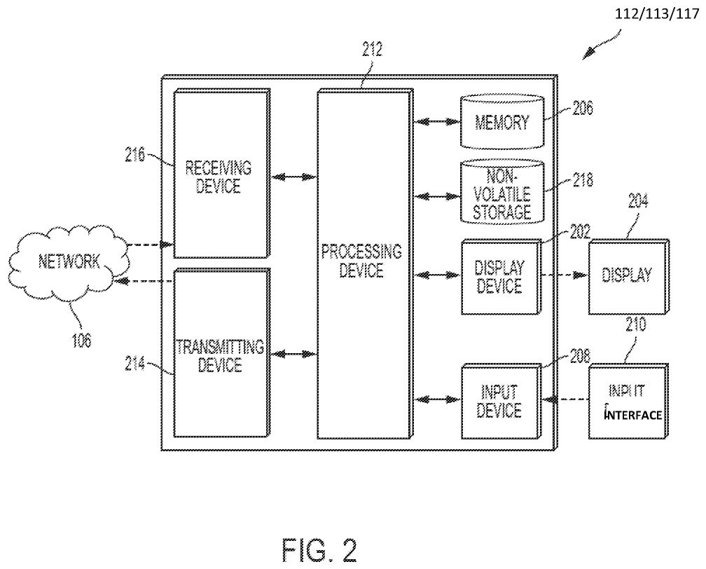

System 100 may include one or more system administrator 107. Admin 107 may use computing device 117 to access, control, program, enter data in, receive data from, and update UIAM Application Entity 120 and other system 100 components. Admin 107 is not limited to an individual with an administrator title, but may include any person or group of people using computing device 117 to manage or otherwise directly alter the software structures, functions, or data of server 120. Computing device 117, discussed in more detail below with reference to FIG. 2, may be any type of computing device suitable for performing the functions and algorithms disclosed herein such a desktop computer, laptop computer, notebook computer, tablet computer, smartphone, etc. Alternative use of a mobile device is also contemplated. Computing device 117 may be connected to a communications network(s), and may connect to UIAM Application Entity 120 therethrough.

UIAM Application Entity 120 may substantially comprise the back-end of UIAM system 100 and may, in various embodiments, include and/or access database 140. As would be appreciated by a person of skill in the art, UIAM Application Entity 120 may comprise a cloud-based server, may comprise one or more server 120 installations, and/or may be a distributed, decentralized entity.

UIAM Application Entity 120 may additionally comprise a plurality of functional software blocks, such as, for example, a data intake engine, an analytics engine, a token distribution block, a blockchain integration block, a financial transaction block, and/or other functional software blocks implicitly or explicitly referenced herein. It is contemplated that UIAM Application Entity 120 may, in some embodiments, further comprise a private blockchain network and/or a public blockchain network.

In some embodiments, certain functional software blocks of UIAM Application Entity 120 may interface with one or more third party services directly and/or over a communications network(s), via, for example, API calls, ABI calls, and/or the like to obtain data or other information; facilitate financial transactions with financial exchange entity 180; and record data in, for example, a blockchain associated with blockchain entity 160. Such data to be obtained may include, for example, ownership-related data, permission access data, financial data, proof of transactions, other data referenced herein, and/or the like.

It is contemplated that, in some embodiments in the asset context, each UIAM Application Entity 120 may be considered to be akin to a mall, flea market, e-commerce platform, and/or the like. That is, each UIAM Application Entity 120 may support sales of multiple types of distinct UIAM-linked assets and from multiple sellers. Each seller 103 may be considered akin to a store of a particular brand. Each seller 103 may have an account within UIAM Application Entity 120, which in certain preferred embodiments, is embodied by (or associated with) seller 103's digital wallet, with account attributes memorialized in a block chain.

In alternative embodiments, each UIAM Application Entity 120 may be associated with a single seller 103. Additionally or alternatively, in various embodiments, each UIAM Application Entity 120 may be associated with a relatively narrow category of UIAM-linked assets (e.g., cannabis clones, cannabis seeds, products from a particular region, and/or the like) may be associated with a broader category of UIAM-linked assets (e.g., cannabis products at large, edible plant assets, plant assets at large, microbial assets, fungal assets, medical assets, and/or the like.)

UIAM Application Entity 120 may be configured to push out application updates to buyer mobile/computing devices 115, seller computing/mobile devices 113, and/or the like.

In some embodiments, for example, as depicted in FIG. 1B, UIAM Application Entity 120 may be distributed on an InterPlanetary File System (IPFS) 150, another decentralized network of servers, a Web 3.0 platform, and/or the like. In such embodiments, UIAM Application Entity 120 maybe considered UIAM decentralized application entity (UIAM d-App) 121. In this manner, UIAM Application Entity 120 may enable, retain, support the execution of, and/or enforce various forms of blockchain-supported smart contracts, including, but not limited to Solidity-based smart contracts configured to run on an Ethereum Virtual Machine and Chain Code-based smart contracts configured for deployment on public-permissionless (e.g., Polygon) and/or private-permissioned blockchains (e.g., Hyperledger fabric, Komodo.)

Database 140/141 may store public-facing and/or proprietary data related to each UIAM token and/or UIAM-linked asset.

Database 140 may comprise one or more physical data storage devices, a cloud-based database, and/or a distributed database. Database 140 may be co-located with processing elements of UIAM Application Entity 120 in some embodiments.

Additionally or alternatively, database 140 may comprise decentralized data storage, utilizing, for example, Web 3.0 distributed data storage protocols and technologies. More specifically, in some embodiments, for example as depicted in FIGS. 1B and 1C, database 140 may be distributed on IPFS 150. In such embodiments, database 140 maybe considered IPFS database 141.

System 100 may include at least one public blockchain entity 160. Public blockchain entity 160 may be connected to a communications network(s), and may connect to UIAM Application entity 120 therethrough. Public blockchain entity 160 may be a third-party enterprise blockchain, but this disclosure is not so limited. In certain preferred embodiments, the Polygon blockchain network may serve as Public Blockchain Entity 160. Vleppo (Vleppo.com) is another example of a potentially suitable public permissionless blockchain entity 160. Public blockchain entity 160 may communicate with UIAM Application entity 120 and reliably record, store, and provide appropriate access to: ownership transactions, UIAM creation and fractionalization events, data access permissions, legal documentation (including, for example, licensing agreements), other forms of data discussed herein, and/or the like in a public blockchain. In preferred embodiments, public blockchain entity 160 may enable and execute smart contract code that complies with, for example, Bitcoin-based proof of work consensus mechanisms; Komodo protocols; Ethereum-based protocols such, as, but not limited to, proof of stake mechanisms; and/or any other suitable blockchain protocol(s). Such protocols, may, for example, be utilized as a means of organizing and providing a mechanism for the sale of and means of validating the actual Identity of a Parent UIAM via external means—e.g., by comparing the stored genetic fingerprint data against a later obtained genetic fingerprint.

System 100 may include at least one financial exchange entity 180. Financial exchange entity 180 may be connected to a communications network(s), and may connect to UIAM Application Entity 120 therethrough. In preferred embodiments, financial exchange entity 180 may be a third-party enterprise that facilitates and executes financial transactions, but this disclosure is not so limited. Financial exchange entity 180 may communicate with UIAM Application entity 120 to reliably and securely withdraw funds (e.g., in the form of ACH, wire transfer, physical currency, cash, credit, debit, crypto-currency, non-fungible tokens, rewards points, tokenized shares or equity stake in a company, etc.) from a buyer 105's funding source; provide funds to a seller 103's financial account; provide funds to an administrator 107's financial account; convert funds from cryptocurrency (e.g., Bitcoin) and/or fiat currency (e.g. US dollars) to fungible Utility Tokens (UTs) to facilitate processing the purchase of goods and services within UIAM Application Entity 120; and/or the like. In certain embodiments, fungible UTs may be created under the ERC 20 protocols or the like. However, it may be noted that stable bank coins (SBCs) (e.g., Tether) may be utilized in in addition to or in lieu of UTs in some embodiments.

Financial exchange entity 180 may, in some embodiments, comprise a more traditional facilitator of financial transactions, for example, VISA, MASTERCARD, Venmo, PayPal, an FDIC insured Bank, and/or the like; and/or may comprise a financial services provider that utilizes a blockchain to maintain a record of transactions. ReThink Bank (https://www.rethinkbank.com/) is an example of a potentially suitable Financial exchange Entity 180 that utilizes its own financial rails and a decentralized quantum financial system to securely and efficiently effectuate and record financial transactions. While a private block chain with a decentralized node may be preferred, this disclosure is not so limited. A private block chain requires a trust relationship and, accordingly, may not be suitable in all circumstance.

In some embodiments of UIAM system 100 (not shown), public blockchain entity 160 and Financial Exchange Entity 180 may comprise a single entity that both handles financial transactions and records transactional and/or other critical data on a public and/or private blockchain(s). Such embodiment may, however, introduce additional regulatory burdens on system 100.

FIG. 2 illustrates an embodiment of mobile and/or computing device 113/115/117 of system 100. It will be apparent to persons having skill in the relevant art that the embodiment of the device 113/115/117 illustrated in FIG. 2 is provided as illustration only and may not be exhaustive to all possible configurations of a device 113/115/117 suitable for performing the functions as discussed herein. Device 113/115/117 may include a display device 202. The display device 202 may be configured to communicate and/or interface with a display 204 to display data to a user 103/105/107. The display 204 may be any type of display suitable for performing the functions disclosed herein, such as a liquid crystal display, light-emitting diode display, OLED display, touch screen display, capacitive touch display, etc. The display device 202 may be configured to transmit data to the display that is stored in a memory 206 of the device 113/115/117.

Device 113/115/117 may include non-volatile storage 218, which can store software and data that would be apparent to persons having skill in the relevant art.

The display device 202 may be configured to display various interfaces and appropriate data to the relevant user 103/105/107. The display device 202 may also display a cursor position, which may allow user 103/105/107 to select an option or a variable, use a dropdown menu, indicate a point of input for text or commands input by the user 103/105/107, and/or facilitate user communication in another fashion known to persons of skill in the art.

Device 113/115/117 may receive input from user 103/105/107 via an input device 208. User 103/105/107 may communicate with the input device 208 via an input interface 210 that is connected to or otherwise in communication with the input device 208. The input interface 210 may be any type of input suitable for performing the functions disclosed herein, such as a keyboard, mouse, touch screen, click wheel, scroll wheel, trackball, touch bad, input pad, microphone, camera, etc. In some embodiments, the input interface 210 and the display 204 may be combined, such as in a capacitive touch display. In some instances, the display 204 and/or the input interface 210 may be included in the device 113/115/117. In other instances, the display 204 and/or the input interface 210 may be external to the device 113/115/117.

Device 113/115/117 may further include a processing device 212. The processing device 212 may be a central processing unit (CPU) or other processor or set of processors suitable for performing the functions disclosed herein as will be apparent to persons having skill in the relevant art. The processing device 212 may receive data associated with input by a user, such as via the input device 208. The processing device 212 may also be configured to read data and software stored in non-volatile storage 218 and memory 206; write data and software stored in non-volatile storage 218 and memory 206; execute program code stored in the memory 206 or non-volatile storage 218, such as embodiments of the algorithms disclosed herein; communicate to other system 100 components on a communications network(s), via receiving device 216 and transmitting device 214; and transmit data to the display device 202 for display to the user 103/105/107 via the display 204. The processing device 212 may be further configured to execute embodiments of the algorithms disclosed herein, as discussed in more detail below. Additional functions performed by the processing device 212 will be apparent to persons having skill in the relevant art and may also be discussed herein.

The memory 206 may store data suitable for performing the functions disclosed herein. Some or all of the data and software stored within non-volatile storage 218 may be copied to memory 206 to support the processing functions of processing device 212.

Device 113/115/117 may also include a transmitting device 214. The transmitting device 214 may be configured to transmit data over a communications network(s), via one or more suitable network protocols. Device 113/115/117 may also include a receiving device 216. The receiving device 216 may be configured to receive data over a communications network(s) via one or more suitable network protocols.

### UIAM Minting Methods

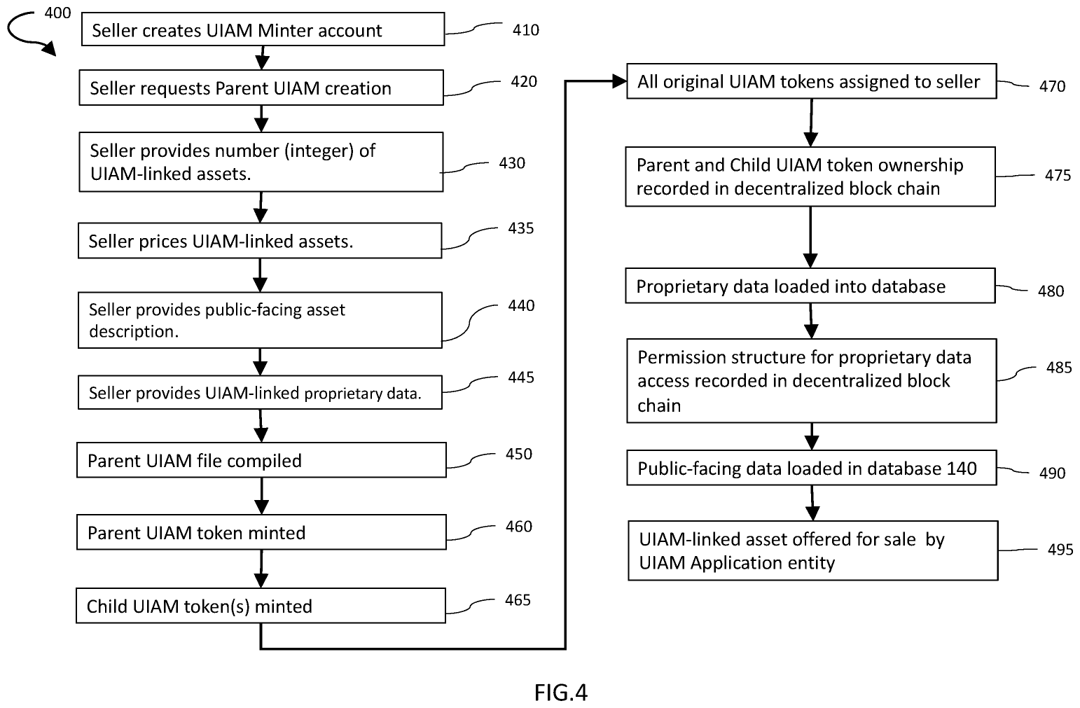

With reference to FIG. 4, an embodiment of a UIAM minting method 400 is provided. As illustrated, UIAM minting method 400 may be understood as pertaining to the UIAM asset context, but may be substantially applicable in other UIAM contexts.

As in step 410, a prospective seller 103 who does not yet have UIAM minting capability/permissions may create a UIAM minter account. In one example, prospective seller 103 may ask for permission to be whitelisted or otherwise authorized to use the minting application.

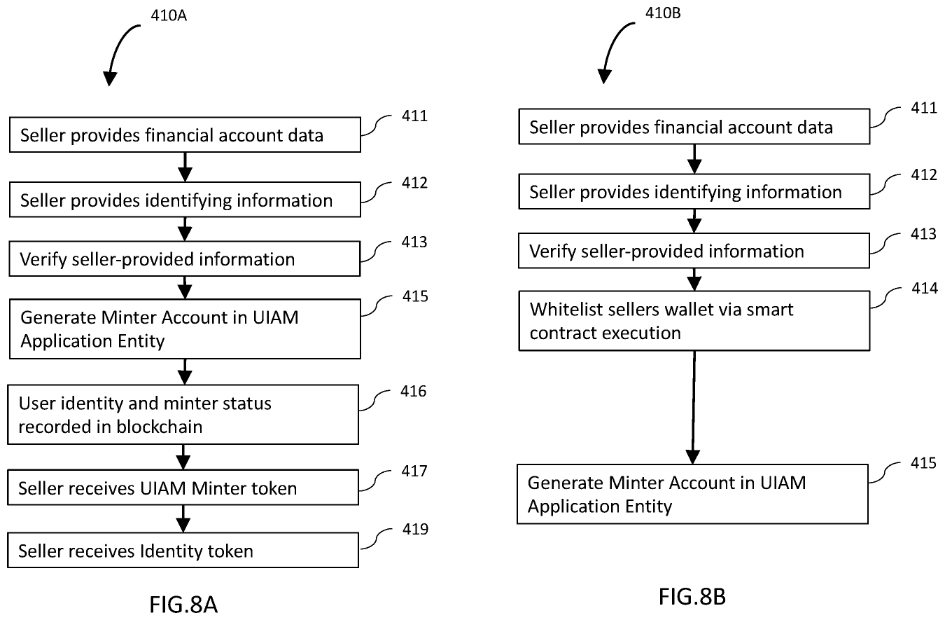

Exemplary sub-steps of a first embodiment of UIAM Minter account creation step 410 are illustrated in FIG. 8A as method 410A, which primarily utilizes tokens to establish minting privileges for a prospective seller. In some embodiments, as appropriate, a genetic digital identity UIAM token, medical digital identity UIAM token, financial digital identity UIAM token and/or the like for the prospective may be created or established prior to step 411.

As in step 411, a prospective seller 103 may provide financial account data to UIAM Application Entity 120. In some embodiments, this may comprise or consist of directly or indirectly connecting a seller 103's financial exchange entity 180 to UIAM Application Entity 120.

As in step 412, prospective seller 103 may provide personal and/or corporate identifying information to UIAM Application Entity 120; such information may additionally include age verification, license and registration information, and/or the like. In some embodiments an identity UIAM token may be utilized.

As in step 413, UIAM Application Entity 120 may verify some or all of the data provided in steps 411 and 412. UIAM Application Entity 120 may utilize financial exchange entity 180 to confirm financial account information. UIAM Application Entity 120 may utilize external governmental or third party entities and/or databases to confirm corporate information, geographic information, licensing and regulatory information, and/or the like. As would be appreciated by persons of ordinary skill in the art, step 413 may additionally or alternatively incorporate various aspects of conventional Know Your Customer (“KYC”) and Office of Foreign Assets Control (“OFAC”) background check protocols and processes. Further, step 413 may, as appropriate, verify that prospective seller 103 possesses the appropriate federal, state, and/or local licensure, approvals, and/or other requirements to sell or commercialize controlled or regulated products, such as, but not limited to plants, tissue cultures, fungal cultures or spores, cell cultures, and/or other genetic items.

After verification, as in step 415, UIAM Application Entity 120 may then generate a Minter account for prospective seller 103. In some embodiments, step 415's generation of a Minter account may coincide with the provision of a token from UIAM Application Entity 120 to an already-existing non-minter account of prospective seller 103 (shown in step 417 of FIG. 8A).

As in step 416, seller 103's identity and minter status may be recorded in a blockchain; a corresponding identity token and corresponding UIAM Minter token that link to the Minter account may be generated. In some embodiments, public blockchain entity 160 may effectuate step 416 and record the information in a public blockchain. Additionally or alternatively, UIAM Application entity 120 may effectuate step 416 and record the information in a private blockchain.

Then, as in steps 417 and 419, UIAM Application Entity 120 may provide the UIAM minter token and Identity Parent UIAM token to seller 103. These tokens may be provided directly to seller 103, may be stored in a crypto wallet as directed by seller 103, and/or may be held by the UIAM Application Entity 120 and associated with seller 103's account. If, however, seller 103 already has an Identity Parent UIAM token, step 419 may be omitted. Further, under such circumstances, seller 103's Identity Parent UIAM token may be utilized as identifying information in step 413 to further streamline method 410A.

In certain embodiments, seller 103's identity and/or minter status may be effectuated in step 416 by whitelisting seller 103's wallet address. In such embodiments, steps 417 and/or 419 may be omitted.

Exemplary sub-steps of a second embodiment of UIAM Minter account creation step 410 are illustrated in FIG. 8B as method 410B, which primarily utilizes a whitelisting smart contract to establish minting privileges for a prospective seller 103.

In method 410B, steps 411, 412, and 413 may proceed as discussed above with respect to method 410A.

After verification, as in step 414, UIAM Application Entity 120 may execute a whitelisting smart contract to authorize prospective seller 103 to open a minting account. More specifically, the whitelisting may be effectuated by authorizing the wallet of seller 103 to create a minter account.

In certain embodiments, it is contemplated that only the Executive Director of UIAM application entity 120 (or another individual or group) acting as Admin 107 may be authorized to execute the whitelisting smart contract, and may do so only after prospective seller 103's identity and compliance requirements have been verified. In other words, UIAM application entity 120 may be configured such that the only way to authorize a minting account is via an executed whitelisting smart contract entered into between the wallet of admin 107 and the wallet of a prospective seller 103.

It is contemplated that such smart contract may be executed within UIAM application entity 120 and published via Public Blockchain entity 160, which in certain preferred embodiments may be a Polygon blockchain. The publication of the smart contract serves to provide an auditable public record of the identity of prospective seller 103, the fact of whitelisting, and the circumstances of such whitelist. In one example, the Executive Director (or other Admin 107) may put prospective seller 103's wallet address into a “whitelist write” section of the whitelisting smart contract; upon executing a “write to” function, the whitelisting is executed, such execution is memorialized as a searchable transaction on the blockchain, and a blank seller profile is created.

After prospective seller 103's wallet is whitelisted with authorization to mint UIAMs, prospective seller 103 may readily proceed to open a minter account. As in step 415, UIAM Application Entity 120 may then generate a Minter account for prospective seller 103 after being whitelisted. The UIAM minter profile account may be permanently associated with prospective seller 103's wallet address.

Returning to FIG. 4, as in step 420, a registered seller 103 may request creation of a Parent UIAM token and (in most circumstances) corresponding Child UIAM token(s) in UIAM Application Entity 120 via computing device 113 and/or paying an appropriate fee. Such fee payment may utilize Financial Exchange Entity 180 in certain embodiments; in other embodiments, such fee payment may use an internal currency of UIAM Application Entity 120. In some embodiments, the Parent UIAM file and/or its components may exist only in UIAM application entity 120 until the minting process is complete.

As in step 430, seller 103 may designate how many units of the physical assets are to be sold in the batch. Such information may be provided to UIAM Application Entity 120 via computing device 113. In some embodiments, common smart contract terms and/or term types may be presented by UIAM Application Entity 120 to seller 120 as selectable and/or modifiable options via a web or application interface on computing/mobile device 113. It is contemplated that some, most, or all smart contract terms may be initially set by default.

Additionally or alternatively, sellers 103 may be presented with the option of generation or coding their own custom smart contract terms. To facilitate this, UIAM Application Entity 120 may provide, perhaps at additional cost, access to a private GitHub repository or the like enabling the generation of custom smart contract terms in a relatively efficient and effective manner. The private GitHub repository may reside in, for example database 140. Additionally or alternatively, the GitHub repository may be tokenized and/or published to IPFS or the decentralized web. Access thereto may be enabled via permissions associated with a seller 103's UIAM Minter token, wallet address, and/or other identification, and may be recorded within, for example, a blockchain of Public Blockchain entity 160.

Also, as in step 430 or otherwise, seller 103 may, perhaps at an additional cost, select Ricardian contract terms that may govern sale of resulting UIAM-linked assets, their resale, offspring assets, permissible asset uses (e.g., use in downstream breeding, licensing agreements, payment scheduling terms, etc.) and/or the like.

As in step 435, seller 103 may designate an initial sale price for each UIAM-linked physical asset unit. Such information may be provided to UIAM Application Entity 120 via computing device 113. In some embodiments, a seller may also engage in auction sales of ownership rights (e.g., to a plant); engage in auction sales of breeding rights (e.g., to a plant); provide payment schedules and alternative terms; provide alternative pricing based on bulk purchases, repeat customers, specified potential buyers 105, and/or potential buyers 105 with particular characteristics; and/or the like. Such sales structures and terms may be effectuated via selected smart contract terms.

As in step 440, seller 103 may provide a public-facing description of the UIAM-linked assets being sold. Such information may be provided to UIAM Application Entity 120 via computing device 113. In some embodiments, seller 103 may directly upload description data components to UIAM Application Entity 120, provide links to description components on the Internet, and/or reference related UIAM tokens. In various embodiments, the public-facing description may include photos, videos, logos, sounds, holographic renderings, augmented reality files, other 3D media, and/or text relating to the UIAM. The description may also comprise branding, logos, trademark information, and/or the like that pertains to seller 103 (and/or other parties involved in the asset's creation, maintenance, and or modification, such as upstream suppliers). This may, in appropriate embodiments, include detail and data regarding flower, fruit, crops, or the like that may be ultimately derived from the UIAM-linked physical asset. Such public-facing description may also, as appropriate, generally describe or otherwise include contractual limitations on a prospective buyer 105's use of the UIAM-linked physical asset (which may be executed via Ricardian Contracts); applicable plant patents, PVPA certificates, and/or other relevant IP; relevant regulatory approvals, licenses, and/or registrations; IP-related licenses or limitations; material transfer agreements; and/or the like.

As in step 445, seller 103 may provide UIAM-linked proprietary data, which may ultimately (in whole or in part) be provided and/or made accessible to buyers 105 after an executed transaction. Such information may be provided to UIAM Application Entity 120 via computing device 113. In some embodiments, seller 103 may upload proprietary data components to UIAM Application Entity 120, provide links (and passwords) to description components on the Internet, include proprietary data by reference to other seller-owned UIAM tokens, and/or the like. Also, as in step 445, seller 103 may, select smart contract terms that may govern a future buyer 105's access permissions to the UIAM-linked proprietary data.

As in step 450, UIAM Application Entity 120 may compile data provided in steps 430, 435, 440, and 445 into a Parent UIAM file.

As in step 460, a Parent UIAM token, which may be indicative of ownership and/or creation of the Parent UIAM file may be minted by the UIAM Application Entity 120. Each minted Parent UIAM token may be permanently associated with its corresponding Parent UIAM file as a transaction record on public blockchain entity 160—and, in some embodiments within UIAM Application Entity 120. Such permanent associations may be effectuated via transaction hashes placed into corresponding smart contracts, via Oracles on the public block chain, and/or the like.

As in step 465, Child UIAM token(s) may be minted, the number of which may correspond with the number of UIAM-linked assets provided by seller 103 in step 430. In some embodiments, a Child UIAM token—especially in the context of genomic physical assets may be further classified based on the type of asset: Such classifications may include seeds, clones, flower, fruit, cell cultures, spores, and/or the like. Data regarding such classification may preferably be embodied within the Child UIAM token. In preferred embodiments, public blockchain entity 160 may effectuate such minting via public blockchain transaction. In alternative embodiments, UIAM Application entity 120 may mint and record each Child UIAM token on a private blockchain. Each minted Child UIAM token may be permanently associated with its corresponding Parent UIAM file within UIAM Application Entity 120 and/or on a public blockchain. Such permanent associations may be effectuated via transaction hashes placed into corresponding, published smart contracts, via Oracles on the public block chain, and/or the like. In other embodiments, the permanent association might not be discernable publicly—or even within UIAM Application entity 120 without sufficient permissions.

As in steps 470 and 475, ownership of the newly minted Parent UIAM token and all Child UIAM tokens may be assigned to the minting seller 103. Such ownership and proof of transaction (e.g., the initial minting) may be recorded in the blockchain of public blockchain entity 160 at the direction of UIAM Application Entity 120 and/or in the blockchain of UIAM Application Entity 120. In preferred embodiments, ownership may be recorded in the blockchain(s) with reference to the seller 103's UIAM Minter token, Identification token, and/or wallet address. The Parent UIAM token and Child UIAM tokens may be provided directly to the seller 103, may be stored in a crypto wallet as directed by the seller 103, and/or may be held by the UIAM Application Entity 120 and associated with a user account of seller 103.

Although steps 460, 465, 470, and 475 are discussed as independent steps, it is contemplated that, in many embodiments, such transactions may be effectuated substantially simultaneously via recordation to a public blockchain.

As in steps 480 and 485, UIAM-linked proprietary data may be published to database 140 and, in most circumstances, set with permission based access by, for example, UIAM Application Entity 120. The permission-based access structure may be set and linked to ownership of each Child UIAM token—as well as the Parent UIAM token—in public blockchain entity 160. UIAM Application Entity 120 may trigger and facilitate this process. In preferred embodiments, UIAM-linked proprietary data access (and write) permissions may be set via smart contract terms, and may be legally effectuated via a Ricardian contract.

In some alternative embodiments, proprietary data modification permissions may be set and linked to ownership of the Parent UIAM token. Additionally or alternatively, the permission-based access structure may be set and linked in UIAM Application Entity 120 and/or a private blockchain therein.

As in step 490 and 495, UIAM-linked public-facing data may be published to database 140/141 by, for example, UIAM Application Entity 120, and the asset may by listed for sale to prospective buyers 105. UIAM application entity 120 may access such public-facing data for provision to potential buyers 105 and to support searches by potential buyers 105. It is contemplated that public-facing data modification permissions may be set and linked to ownership of the Parent UIAM token.

In alternative embodiments, the UIAM-linked public-facing description may be fully or partially published as an Oracle to Public Blockchain entity 160 in lieu of or in addition to uploading to database 140/141.

In some embodiments, the published public-facing data may be configured such that APIs (or ABIs) of, for example, product sale aggregator applications, e-commerce websites, and the like, may access it and thereby direct potential buyers 105 to UIAM application entity 120.

At the conclusion of method 400, the UIAM-linked assets may be considered ready for sale and subsequent transactions.

### UIAM-Linked Asset Purchase Methods

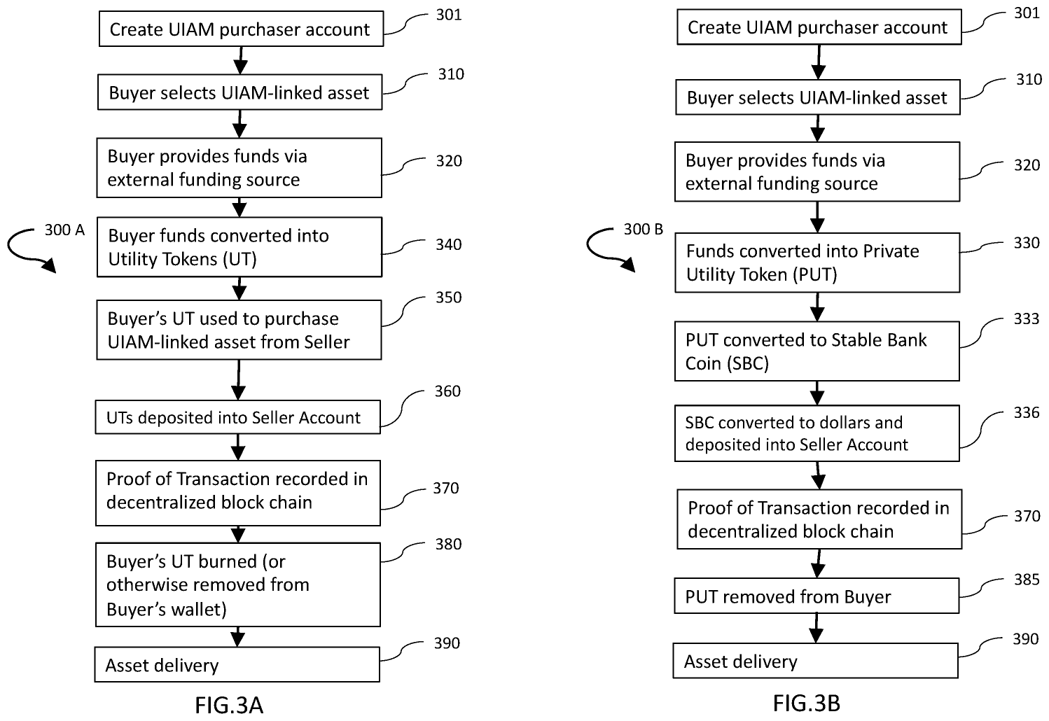

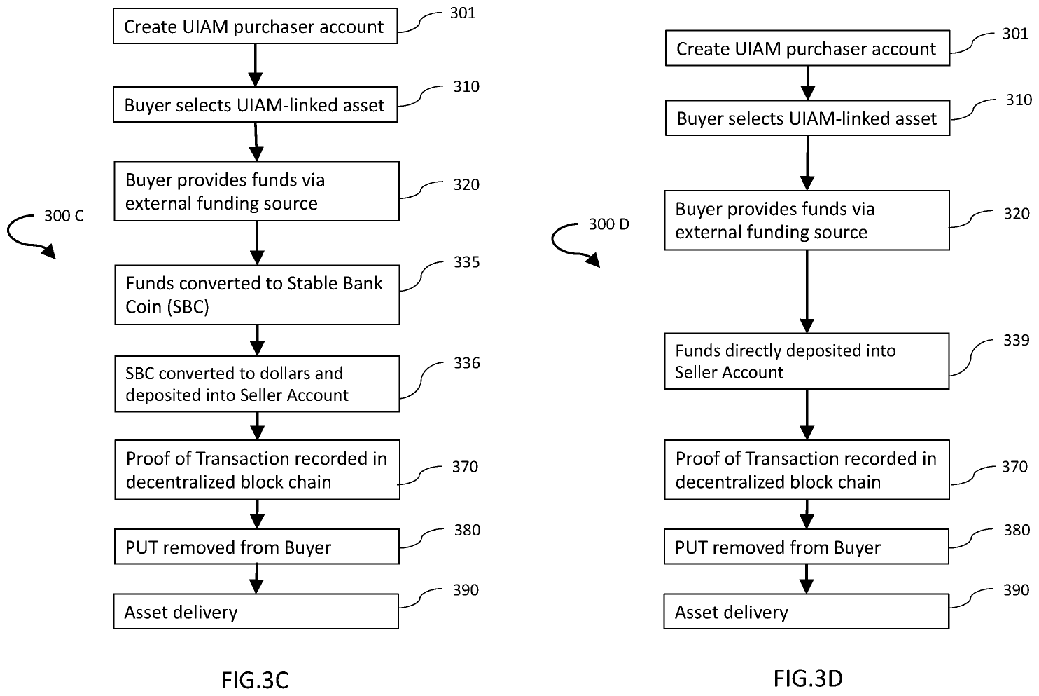

With reference to FIG. 3A, an embodiment of a UIAM-linked asset purchase method 300A is provided.

As in step 301, a prospective buyer 105 may create a purchaser account if he or she does not already possess one and/or is not already registered as a seller 103.

Exemplary sub-steps of UIAM Purchaser account creation step 301 are illustrated in FIG. 7. As in step 302, a prospective buyer 105 may provide financial account data to UIAM Application Entity 120. In some embodiments, this may comprise or consist of directly or indirectly connecting a buyer 105's financial exchange entity 180 to UIAM Application Entity 120.

As in step 303, prospective buyer 105 may provide personal and/or corporate identifying information to UIAM Application Entity 120; such information may additionally include age verification, license and registration information, and/or the like.

As in step 304, UIAM Application Entity 120 may verify some or all of the data provided in steps 302 and 303. UIAM Application Entity 120 may utilize financial exchange entity 180 to confirm financial account information; UIAM Application Entity 120 may utilize external governmental or third party entities and/or database to confirm corporate information, geographic information, licensing and regulatory information, age information, and/or the like. As would be appreciated by persons of ordinary skill in the art, step 304 may incorporate various aspects of conventional Know Your Customer (“KYC”) protocols and processes.

After successful verification, as in step 305, UIAM Application Entity 120 may then generate a purchaser account for prospective buyer 305.

As in step 306, buyer 105's identity may be recorded in a blockchain, a corresponding identity token that corresponds to the purchaser account may be generated. In some embodiments, public blockchain entity 160 may effectuate step 306 and record the information in a decentralized blockchain. Additionally or alternatively, UIAM Application entity 120 may effectuate step 306 and record the information in a private blockchain. Then as in step 309, UIAM Application Entity 120 may provide the Identity token to buyer 105. This token may be provided directly to the buyer, may be stored in a crypto wallet as directed by the buyer, and/or may be held by the UIAM Application Entity 120 and associated with buyer 105's account.

In certain embodiments, step 309 may be omitted. In one example, buyer 105's identity recordation may be effectuated in step 306 by whitelisting buyer 105's wallet address, negating the need for a buyer identity token. In another example, the whitelisting step may be omitted as it may be assumed that any user with a purchaser account is a verified buyer 105.

Returning to FIG. 3A, as in step 310, a verified buyer 105 may select a UIAM-linked asset for purchase. Buyer 105 may, in various embodiments, make such selection on a mobile, computer, or web-based application of UIAM Application Entity 120; an e-commerce website linked to UIAM Application Entity 120 via, for example an API; and/or in a brick-and-mortar store that interfaces with UIAM Application Entity 120.

As in step 320, buyer 105 may provide funds to purchase the selected UIAM-liked asset via an external funding source. The external funding source may comprise credit, debit, ACH, cash or paper check (as may be appropriate for brick-and-mortar purchases), cryptocurrency, and/or the like. In some embodiments, buyer 105 may utilize an application on mobile/computing device 115 to select a pre-registered funding source among one or more potential sources that was provided and/or verified as in steps 302, 304, and/or the like. In some embodiments, buyer 103's funding source may be pre-selected and proceed with automatically and/or with a simple confirmation.

Upon establishing a funding source, UIAM Application Entity 120 may direct Financial Exchange Entity 180 to retrieve funds for the purchase and provide them to UIAM Application Entity 120. In some embodiments, the retrieved funds may be placed within a financial account at Financial Exchange Entity 180 that is owned and/or managed by UIAM Entity 120.

As in step 340, upon receiving the funds, UIAM Application Entity 120 may convert the funds into Utility Tokens (UT), and record buyer 105's ownership therein and thereof. For example, UIAM Application Entity 120 may provide UTs commensurate with the provided funds into buyer 105's wallet within UIAM Application Entity 120. In some preferred embodiments, each UT may be pegged to a certain fiat currency value, for example $1 US. Additionally, it may be preferred that UTs be created under the ERC 20 protocols or the like. However, UTs minted via BEP 20 protocols or the like are also specifically contemplated by this disclosure.

It is contemplated that, in certain embodiments, ERC 20-based UTs may be minted by UIAM Application Entity 120. In some embodiments, ERC 20-based UTs may be minted by via the wallet maintained by the Chief Financial Officer of UIAM Application Entity 120 (who may be considered admin 107 for such purpose). In other embodiments ERC 20-based UTs may be minted by via a multi-signature wallet that requires approval from multiple executives, employees, and/or board members of UIAM Application Entity 120 to effectuate minting (who may collectively be considered admin 107 for such purpose).

Utility Tokens (UTs) may be generally understood to be a fungible token minted and maintained on a blockchain network and used for at least one—and typically only one—specific purpose. UTs may be considered as an asset class. In preferred embodiments of the instant disclosure, is contemplated that UTs may only have utility as native currency within UIAM Application Entity 120—namely for the purchase of goods and services from UIAM Application Entity 120 (e.g., the service of minting new UIAMs, the provision of smart contracts, etc.) and/or for commerce with other users 103/105 (e.g., the purchase or sale of Child UIAM tokens and associated assets, the provision of royalty payments, and/or the like). Furthermore, in some embodiments, such UTs may not be exchanged or utilized by any user of UIAM Application Entity 120 unless their wallet is whitelisted (e.g., my means of a smart contract or token) for such purposes. In this manner, the executive director (or other admin 107) of UIAM Application Entity 120 may exert additional control over commerce within UIAM system 100.

In certain embodiments and circumstances, steps 320 and 340 may be omitted entirely or may be substantially effectuated outside of UIAM Application Entity 120. In a first example, a buyer 105 may already have sufficient UTs to effectuate the desired financial transaction; in such circumstance, steps 320 and 340 maybe omitted entirely.

In another example, a buyer may acquire UTs via an external cryptocurrency exchange and/or another financial services MSB (money service business); such acquired UTs may then be transferred to buyer 105's wallet within UIAM Application Entity 120. Because, in this embodiment, the funds are converted to UTs by a financial entity separate from system 100, the securities regulation burdens otherwise borne by UIAM Application Entity 120 (and/or system 100 at large) may be reduced and/or substantially eliminated. It is contemplated that, in some embodiments, UIAM Application Entity 120 may mint UTs and place them into a liquidity pool or other external exchange that would enable prospective buyers 105 (and sellers 103) to readily acquire them in exchange for fiat currency, cryptocurrency, or other assets.

As in step 350, buyer 105's UTs may be utilized to purchase the selected UIAM-linked asset(s) from seller 103. In the typical instance in the UIAM asset context, buyer 105 may be purchasing a Child UIAM token(s) and associated goods, data, and/or services.

As in step 360 the UTs may be deposited into seller's account and/or wallet. UIAM Application Entity 120 may direct this process as appropriate. In contemplated alternative embodiments of step 360, the UTs may be deposited into an escrow account, or otherwise held in escrow by system 100, for example by UIAM entity 120, until asset delivery (for example, as in step 390 below) has been effectuated and/or confirmed. In some preferred embodiments, the financial terms and conditions of contemplated transaction, including provisions governing non-payment or non-delivery, may be set out in a Ricardian Contract.

As in step 370, Public Blockchain Entity 160 may record proof of the transaction on its public decentralized blockchain. In certain preferred embodiments, recordation on the blockchain may comprise transfer of ownership of the UIAM token to the buyer 105 by linking the token to buyer 105's wallet address. Additionally or alternatively, the Child UIAM token indicating buyer 105's ownership of the purchased asset may be provided directly to the buyer 105, may be stored in a crypto wallet as directed by the buyer 105, and/or may be held by the UIAM Application Entity 120 and associated with buyer 105's account. UIAM Application Entity 120 may direct this process as appropriate. Additionally or alternatively, UIAM Application Entity 120 may record proof of the transaction on its private blockchain or using IPFS as a ledger to record transactions. UIAM Application Entity 120 may additionally or alternatively record proof of the transaction using IPFS as a digital ledger and/or via an Oracle.

As in step 380, UIAM Application Entity 120 may remove the UTs from buyer's account. In certain preferred embodiments, the UTs removed from buyer 103's account may be burned. Such actions may be recorded on a private blockchain of UIAM Application Entity 120, a public blockchain of Public Blockchain Entity 160, and/or stored in a centralized digital ledger.

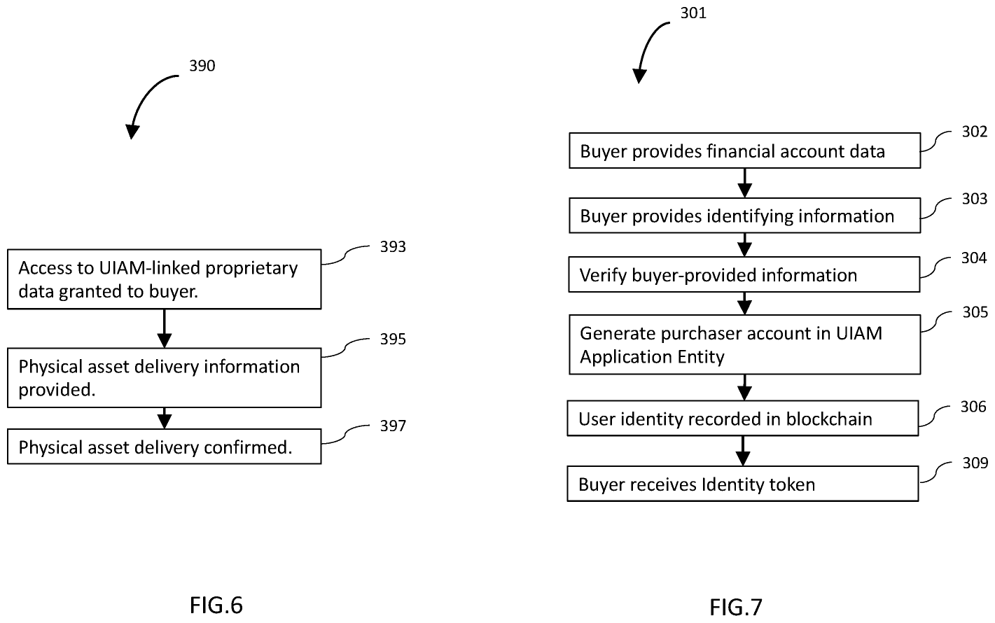

As in step 390, the purchased assets may be delivered to buyer 105. Exemplary sub-steps of UIAM-linked asset delivery 390 are illustrated in FIG. 6.

As in step 393, buyer 105 may be granted access to UIAM-linked proprietary data. Such propriety data may be stored in database 140, such as, for example, IPFS database 141, and access may be granted via buyer 105 identity confirmation by UIAM Application Entity 120 and/or Public Blockchain Entity 160. A person of ordinary skill in the art would be familiar with Web 3.0 interfaces, including IPFS protocols, and would readily understand the technical processes that may provide permissioned access to private data. Permissioned access may be governed by Smart Contract terms within the UIAM token, the terms of which may be established in, for example, step 445 of method 400.

As in step 395, seller 103 may be provided with physical asset delivery or pick-up information. For example, UIAM Application Entity 120 may provide buyer 105's physical address or preferred method of delivery for the physical asset. Upon receiving such data, seller 105 may ship the UIAM-linked physical asset to buyer 105. In some embodiments, as appropriate, seller 103 may submit package tracking information and/or a pick-up geolocation to UIAM Application Entity 120, which, in turn may be provided to buyer 105.

As in step 397, delivery of the UIAM-linked physical asset may be confirmed, such confirmation may further be logged by UIAM Application Entity 120. Delivery confirmation may comprise an affirmation of receipt by buyer 105; a confirmation of delivery by a delivery service, a confirmation of pick-up, and/or the like. In alternative embodiments, where UTs (or other currency, discussed below) are held into escrow in step 360 (or steps 336 or 339, discussed below), such escrowed proceeds may be deposited into seller 103's account.

After step 390, the buy/sell transaction may be understood to have been completed.

With reference to FIG. 3B, an embodiment of a UIAM-linked asset purchase method 300B is provided.

In method 300B, steps 301, 310, and 320 may proceed as discussed above with respect to method 300A.

Then, as in step 330, upon receiving the funds, UIAM Application Entity 120 may convert the funds into Private Utility Tokens (PUT) via its private blockchain, and record buyer 105's ownership therein and thereof. A PUT may be understood to be a private cryptocurrency maintained on a private blockchain network. In some preferred embodiments each PUT may be pegged to a certain fiat currency value, for example $1.

As in step 333, UIAM Application Entity 120 may engage Financial Exchange Entity 180 to convert the PUTs into SBC and/or engage Public Blockchain Entity 160 to record such transaction on its public blockchain. UIAM Application Entity 120 may record a transfer of the PUTs to seller 103.

As in step 336, Financial Exchange Entity 180 may convert the SBCs into fiat currency and deposit the funds into seller 103's account. UIAM Application Entity 120 may direct this process as appropriate. In contemplated alternative embodiments of step 336, the SBCs may be deposited into an escrow account, or otherwise held in escrow by system 100, for example by UIAM entity 120, until asset delivery (as in step 390) has been confirmed.

Method 300B may then move to step 370, which may proceed as discussed above with respect to method 300A.

As in step 385, UIAM Application Entity 120 may remove the PUTs from buyer's account and record such transaction on its private blockchain. In various embodiments, the PUTs removed from buyer 103's account may be burned and/or recycled for use in future transactions.

Method 300B may then move to step 390, which may proceed as discussed above with respect to method 300A. Then, the buy/sell transaction may be understood to have been completed.

With reference to FIG. 3C, an embodiment of a UIAM-linked asset purchase method 300C is provided. UIAM-linked asset purchase method 300C may contemplates a system 100 structure where, for example, UIAM Application Entity 120 and financial exchange entity 160 are effectively merged. Method 300C is substantially the same as method 300B, but no Private Utility Tokens (PUT) are utilized; steps 330 and 333 are replaced by step 335.

As in step 335, upon receiving the funds, UIAM Application Entity 120/financial exchange entity 160 may convert the funds into SBCs and record such transaction on its public and/or private blockchain and/or using IPFS as a ledger. UIAM Application Entity 120/financial exchange entity 160 may record a transfer of the SBCs to seller 103.

With reference to FIG. 3D, an embodiment of a UIAM-linked asset purchase method 300D is provided. UIAM-linked asset purchase method 300D contemplates a system 100 structure where, for example, UIAM Application Entity 120/financial exchange entity 160 are effectively merged. Method 300D is substantially the same as method 300C, but no SBCs are utilized; steps 335 and 336 are replaced by step 339.

As in step 339, upon receiving the funds from buyer 105's financial account(s), UIAM Application Entity 120/financial exchange entity 160 may directly deposit corresponding funds into seller 103's accounts. UIAM Application Entity 120/financial exchange entity 160 may record the funds transfer. In contemplated alternative embodiments of step 339, the funds may be deposited into an escrow account, or otherwise held in escrow by system 100, for example by UIAM entity 120 and/or financial exchange entity 160, until asset delivery (as in step 390) has been confirmed.

### Exemplary Genomic Product UIAM Embodiments

One prominent use case for the UIAM framework is commerce in genomic products, wherein a product's value may be substantially dependent on its cultivar, strain, cell line, and/or other genetic lineage. Currently, commerce in genomic commerce is inefficient and beset by substantial challenges. For example, it is difficult for a prospective buyer to be sure that the genomic product they are purchasing is what the seller represents it is. While conducting real-world verifications may be possible, conducting such verifications are simply too expensive and impractical unless genomic products are purchased on a sufficiently large scale or are extremely valuable. As another example, a seller of clones or seeds of a particularly valuable plant varietal may be willing to have buyers grow their varietal, but be unwilling to permit downstream cross-breeding. While such arrangements can be secured via traditional written contracts, this is too expensive and impractical in all but the rarest circumstances. In other words, the transaction costs are often too high for an otherwise willing buyer and seller of genomic products to strike a deal and execute the transaction. The utilization of the UIAM framework in this context can solve or mitigate these problems.

Consistent with UIAM minting method 400 discussed above, a Parent UIAM token may represent a genomic asset. For illustrative purposes, the parent genomic asset may be a cannabis plant of a particularly desirable cultivar, but this disclosure is not so limited. In this example, the UIAM-linked assets to be sold may be, for example, clones/cuttings, seeds, cannabis flower, and/or processed product from the cannabis flower. In minting a Parent genomic product UIAM token, Seller 103 may be required or encouraged by UIAM Application entity 120 to provide the cultivar name; a gene sequence file; a botanical description; geolocation data relating to where the plant or the like was grown and/or acquired; a certificate of analysis (e.g., providing the cannabinoid and/or terpene levels of the plant or flower); methods of agronomy; agronomy data aggregated that produced a specific result in that genome during those specific environmental conditions or season; clinical or anecdotal data regarding uses; and/or the like. In various embodiments and circumstances, certain of these data sets may be considered part of the public-facing asset description (as in step 440) and/or UIAM-linked proprietary data (as in step 445).

It is contemplated that a substantial proportion provided data is substantially verifiable by buyers 105 (e.g., via sequencing on the genetic product of the Child UIAM token). In certain embodiments is contemplated that the gene sequence file may comprise a full gene sequences, partial genetic fingerprints, genetic sequencing (e.g., based on Bioinformatics from Oxford Nanopore, QPCR electro gel, etc.), and/or the like. With respect to cannabis genetics, most genetic fingerprinting is effectuated by three companies—Medicinal Genomics, Leafworks, and Delta Leaf Labs. Given the variety of genetic fingerprint data formats and structure among these and other companies, it is contemplated that validation of genetic identity of a UIAM asset may preferably be performed by the same company (or at least the same technique) that prepared the initial genetic fingerprinting incorporated in the UIAM-linked proprietary data.

In view of, for example, such genetic fingerprinting and the immutable, public audit trails on the public blockchain, fraudulent sales or other activity on system 100 may be easily identifiable and investigable by the consumer, an investigator, and/or a regulatory authority. Moreover, it is contemplated that discovery of a single fraudulent representation by a seller 103 would likely cause the seller to be banned from UIAM System 100 and/or suffer severe reputational damage, which may be documented on future sales listings by the offending seller. In this manner, “bad” behavior on the part of system 100 participants is powerfully discouraged. Accordingly, buyers 105 of genomic products linked to Child UIAM tokens may be confident in their expectation that they will receive exactly what they intended to purchase. And, regulators may have confidence in the operation of system 100 and its participants at large.

Buyers 105 of seeds, clones, or the like that are linked to Child UIAM tokens may be provided with another benefit of the UIAM framework—namely, the efficient and effective validation of genomic products in downstream sales. Child UIAM tokens that represent cultivatable genomic assets may be referred to as Gen2 UIAM tokens. In preferred embodiments, the genomic asset (e.g., seed or clone) of a Gen2 UIAM tokens may be understood to have an identical or substantially similar genetic sequence as the genomic asset of its Parent UIAM token. For example, if the batch of UIAM-linked physical assets is to include 60 genetically identical cuttings, 60 Child UIAM tokens may be generated, with one token linked to each specific individual cutting. In this example, each Child UIAM token may be considered a Gen2 (Child) UIAM token and may include particular breeding rights or the like that are memorialized and embodied in the Gen2 UIAM token.

In many circumstances, the buyer 105 of a Gen2 UIAM token may be expected to cultivate and/or breed the purchased genomic asset. And, in turn, buyer 105 may seek to sell the resulting genomic products via the UIAM framework. Consistent with embodiments of method 400, the Gen2 UIAM token may be treated as a Parent UIAM (as in step 420) and the downstream genomic assets may be sold as UIAM-linked assets, wherein a Grandchild/Gen3 UIAM token may be minted for each downstream genomic asset to be sold.

The lineage of these downstream genomic assets may be readily established in the blockchain for each Grandchild/Gen3 UIAM token. Moreover, the processes of inputting a public-facing asset description (as in step 440) and/or UIAM-linked proprietary data (as in step 445) may be substantially reduced and/or eliminated wherein such data have already been associated with the linked Gen2 UIAM token, which is the Parent UIAM token to the Grandchild/Gen3 UIAM token. In certain embodiments, UIAM tokens for related genomic asset containing identical genetics, substantially identical genetics, and/or a common lineage may be linked by utilizing the ERC 721 and/or ERC 998 composable smart contract standards on, for example the Polygon blockchain.

In certain preferred embodiments, it is contemplated that Gen2 UIAM tokens may be bound to a Ricardian Contract that embodies a legally binding material transfer agreement or similar contract. Such Ricardian Contract terms may indicate whether it is permissible for the buyer 105 to cultivate Gen3 genomic assets; limitations on such cultivation, including temporal limitations, geographic limitations, sales channel limitations, limitation regarding cloning vs. self-pollinating vs. cross-breeding, limitations on total downstream production, and/or the like; requirements that downstream cultivation follow a particular agronomy (which may for example be provided in an Oracle and/or as UIAM-linked proprietary data); royalty terms, other license terms, and/or the like. It is further contemplated that smart contract terms embedded in Gen2 UIAM tokens may automatically ensure that at least certain Ricardian contract terms are followed. For example, such smart contract terms may include code providing for royalty payments corresponding to the Gen3 UIAM token (and downstream) sales; limitations on the creation of Gen3 UIAM tokens, including, for example, total number, type (e.g., Gen3 UIAM tokens of the flower type may be minted, but clones or seeds may not), timing (e.g., Gen3 UIAM tokens may only be minted until a certain date), and/or the like; further downstream limitations (e.g., no Gen4 tokens may be minted); and/or the like.

### UIAM Offspring Generation Methods

An additional advantage of utilizing the UIAM framework for genomic assets is the enabling of efficient contracting for collaborative cross-breeding. For example, two agricultural breeders, animal breeders, and/or the like may utilize UIAM system 100 when cross-breeding their respective genomic assets to fairly, securely, and efficiently establish ownership and other rights relating to offspring resulting from the collaboration; maintain an immutable and reliable record of lineage; and/or readily enable sales the offspring as UIAM-linked assets.

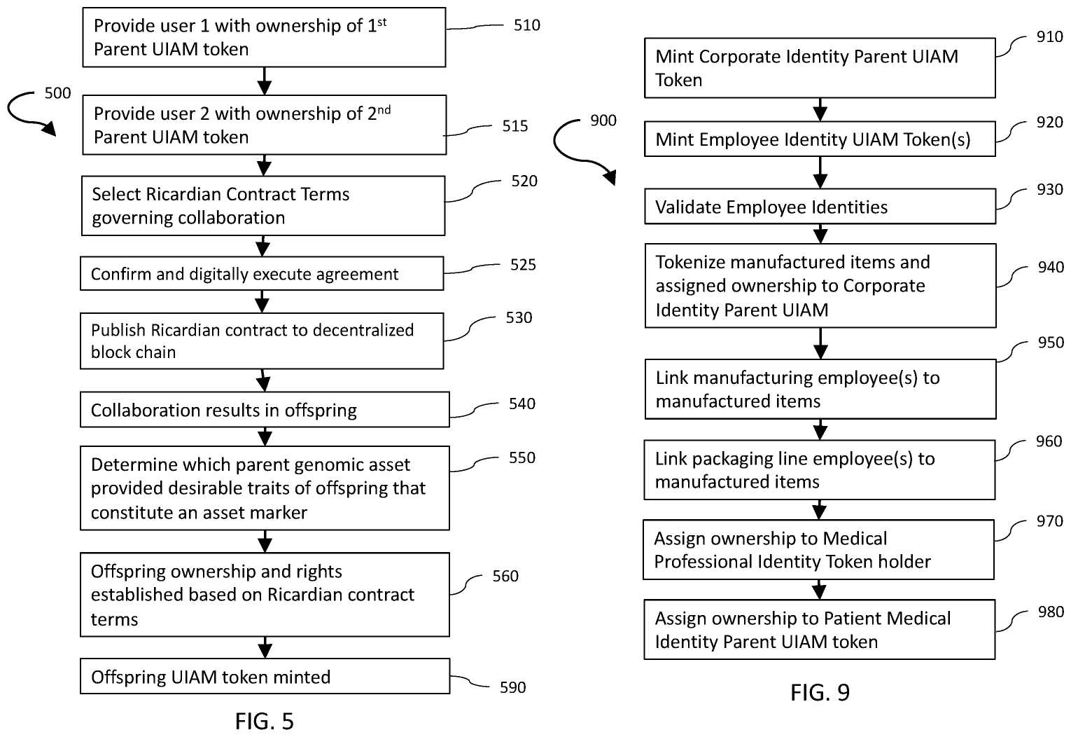

With reference to FIG. 5, an embodiment of collaborative UIAM minting method 500 is provided.

As in step 510, a first user who owns a 1st Parent UIAM token and its corresponding genomic asset may be provided.

As in step 515, a second user who owns a 2nd Parent UIAM token and its corresponding genomic asset may be provided.

As in step 520, the first and second users may negotiate the terms of the collaboration, ultimately arriving on Ricardian contract terms. The users may, perhaps at an additional cost, select Ricardian contract terms that may govern ownership of resulting offspring, downstream breeding rights, splitting of downstream sales proceeds, and/or the like. It is contemplated that, in some embodiments, selectable smart contract terms may include permissions or rights to auction or sell downstream breeding rights, transfer(s) of ownership, and/or licensing agreement(s). In some embodiments, common terms and term types may be presented by UIAM Application Entity 120 to the users as selectable and/or modifiable options via a web or application interface on computing/mobile devices 113. It is contemplated that most or all smart contract terms may be initially set by default.

Additionally or alternatively, users may be presented with the option of generating or coding their own custom smart contract terms. To facilitate this, UIAM Application Entity 120 may provide, perhaps at additional cost, access to a private GitHub repository enabling the generation of custom smart contract terms in a relatively efficient and effective manner. The private GitHub repository may reside in, for example database 140.

Relevant Ricardian contract terms may, for example, include granting a higher proportion of offspring ownership or the like to the user who bred and/or grew the desirable offspring. Additionally or alternatively, Ricardian contract terms may include granting a higher proportion of offspring ownership (and/or downstream sales revenue) based on the which parent genomic asset provided one or more desirable traits (or phenotypes).

As in step 525, the first and second users may confirm their assent to the negotiated collaboration agreement and execute the Ricardian contract. This document may be digitally signed, for example via the Vleppo API, DocuSign, or the like, at the time of smart contract execution. The executed plain text Ricardian contract may provide legal recourse to the respective parties if disagreements later arise.

As in step 530, UIAM Application entity 120 may direct public blockchain entity 160 to publish a transaction indicative of the agreement on a decentralized blockchain. In certain embodiments, the Ricardian Contracts may be published on the Alysides Blockchain (a fork of the Komodo Blockchain).

As in step 540, the users may engage in their breeding collaboration. It is contemplated that the breeders and/or buyers may be given the opportunity to pheno-hunt (e.g., selecting the best phenotype of a strain for a particular purpose) for desirable offspring. For the purposes of illustrating method 500, it may be assumed that the collaboration results in at least one desirable offspring.

As in step 550, assuming that it is relevant to the agreed-upon Ricardian contract terms, it may be determined which parent genomic asset(s) provided desirable trait(s) in the offspring. In certain preferred embodiments, as further discussed below, the genotypes of the parent genomic assets may be compared with expressed phenotypes in the offspring, preferably taking into account environmental factors that may be relevant to phenotypical expression of genotypes passed to the offspring. In alternative embodiments, the offspring may be genetically sequenced. Based on such sequencing, UIAM Application Entity 120 may utilize, for example, AI machine learning and data analytics with the genomic sequencing of the offspring and the parents to determine which parent provided the desirable trait(s).

As in step 560, offspring ownership and other rights may be determined based on the Ricardian contract terms and results of the breeding collaboration.

As in step 590, an Offspring UIAM token be minted. This may proceed in a substantially similar manner as method 400, but it is contemplated that Offspring UIAM token will also link to the UIAM Parent Tokens and files of its lineage. Relevant offspring ownership and other rights, as may be determined in step 560, may preferably be included in the Offspring UIAM file and token. For example, public-facing data of the 1st Parent UIAM file and the 2nd UIAM Parent file may be made available for potential buyers 105 of the UIAM-linked offspring. In some embodiments, access to some or all proprietary data of the 1st Parent UIAM file and the 2nd UIAM Parent file may be made available for holders of offspring Child UIAM tokens. Additionally, it is contemplated the blockchains associated with Offspring UIAM file creation may serve to establish proof of elapsed time, proof of ownership, and/or the like by, for example, publishing a transaction hash to a public permissionless blockchain using smart contracts.

In related embodiments, Ricardian contracts may be utilized to enter into a licensing agreement or purchase the breeding rights to a Parent UIAM token and associated genomic product and/or its offspring. For example, a Ricardian contract may define may define time periods, regions, royalties, and other terms for breeding. Corresponding smart contract code may provide for automatic payments to specific wallet addresses.

While the disclosed methods and systems are substantially explained herein in the context of transferring and/or licensing genomic assets, they are not so limited. That is, the disclosed UIAM methods and systems may be embodied in other contexts and technologies, as would be understood by a person of ordinary skill in the art.

### UIAM Epigenetic Discovery Embodiments

In some embodiments, the UIAM framework may be utilized to record and track potential causes of phenotypical expression of genotypes on a blockchain. While plants, and cannabis plants in particular, are discussed herein for illustrative purposes, such methodology is also applicable to humans, other animals, fungus, microorganisms, even RNA viruses, and/or the like.

A Genotype Parent UIAM Token may reflect a specific genetic individual or organism. In preferred embodiments, the Genotype Parent UIAM Token may be created via the ERC 721 standard. Phenotype Child UIAM tokens may collectively represent all known phenotypical traits, and each may be specific to recorded environmental conditions, such as temperature, humidity, light cycles, fertilizers, irrigation levels, etc. In preferred embodiments, each Phenotype Child UIAM Token may be created via the ERC 1155 or 721 standard.

In one example, Gen2 UIAM purchasers may be provided with access to both Genotype Parent UIAM Tokens and Phenotype Child UIAM tokens relating to the purchased genetic asset. Via smart contracts, the purchasers may be provided rights to access or publish propriety data regarding the same. Additionally, the Gen2 UIAM purchasers may be provided rights to mint additional Phenotype Child UIAM tokens based on the phenotypical traits expressed by the purchased genomic asset and the specific environmental conditions where such phenotypical expression occurred. To facilitate this process it is contemplated that the grown genomic assets be subjected to chemical qualitative and quantitative laboratory analysis and produce a document certificate of analysis.

Phenotype Child UIAM tokens from Gen2 UIAM purchasers (and other downstream purchasers) may ultimately be aggregated to discern which environmental conditions may be most helpful (or harmful) in obtaining various desirable phenotypical expressions for a particular genotype. Such data may ultimately increase the value for a particular genotype and be included as proprietary instructions for future sales of the genomic asset.

Ultimately, after multiple genotypes are mapped to beneficial phenotypical expressions, full genome sequencing may be run to map alleles and determine which genetic regions were likely responsible for specific phenotypical expressions.

### Exemplary Personal Identity UIAM Embodiments

In other embodiments, Parent UIAM tokens may be utilized as a reliable means of identifying a particular individual. Such embodiments could be used to confirm identities to, for example, verify voters, prevent identity theft (e.g., by utilizing a token instead of a physical identity card or Social security number that is subject to theft).

In certain embodiments, it is contemplated that an Identity Parent UIAM token may comprise a Soul Bound token and may be held in a Soul wallet. These particular blockchain structures may be preferred for identity Parent UIAMs because they do not enable transfer of ownership.

### UIAM Medical Data Embodiments

Outside of the asset sales context, the teachings of aspects of the instant disclosure may be utilized to facilitate the provision of customized medical, wellness, and/or health-related related goods and services.

A medical identity Parent UIAM may embody an expression of individual's genetic fingerprint (e.g., a gene sequence file), an individual's full (or partial) medical record, an individual's physiological data (for example, gathered by a smart watch, FitBit®, medical devices, and/or other biometric sensor devices), and/or the like. It is contemplated that the owner of a medical identity Parent UIAM may generate medical identity Child UIAMs and transfer them to others' Parent Identity UIAMs to facilitate medical treatment, to facilitate wellness treatment, to facilitate anonymized medical research, and/or the like.

In one embodiment, a Digital Medical Identity Parent UIAM token may be minted for an individual patient. The token may provide access to and broadly correspond to a person's medical data, including their genetic fingerprint, which may also serve to verify the patient's identification as appropriate. The medical data may include sensitive information such as an individual's genomic data, medical history medical diagnosis and interpretations, predispositions to a particular disease, metabolic data, allergy information, lab blood work, and/or the like. In certain embodiments, such sensitive medical data may be placed in a SHA 256 or similar encryption algorithm vault and/or cryptographically secure tokenized data container. In turn, it is contemplated that the owner of the corresponding Digital Medical Identity Parent UIAM token (or Financial Parent token) could access such data. Further, it is contemplated that the Digital Medical Identity Parent UIAM token owner may mint corresponding child UIAM tokens to give permanent or temporary (e.g., for a limited time period) access to specific individual medical providers; persons associated with a particular hospital, hospital system, and/or medical practice; close family members; insurance personnel; and/or the like. In some embodiments, access may be broadly or automatically given to relevant persons with a particular Medical Professional Identity Token.

In some embodiments, Digital Medical Identity Parent UIAMs may also aggregate diagnostic health data from various hardware and/or software sources, for example smart watches (e.g., the Apple® Watch), and/or other devices that collect biometric data via heart rate monitors, skin temperature sensors, movement sensors, breath rate sensors, blood sugar sensors, and/or other metabolic or physiological relevant medical sensors data. These data points may be tokenized, preferably using the 998 composable top down, the ERC 1155, and/or ERC 721 token standards.

In various embodiments, medical identity Child UIAMs may provide full or partial access to an individual's medical record and related data to a medical or wellness professional (or medical or professional algorithm) for a limited amount of time or until access is withdrawn by the Parent UIAM. In some embodiments, medical identity Child UIAMs may provide access to medical and related data to researchers, but without actually transferring the individual's identity to the researchers. Further, in some embodiments, a physician may provide a prescription to a patient by means of transferring a corresponding Prescription Child UIAM to the patient's medical identity Parent UIAM. In turn, anonymized statistical data regarding a patient's tokenized prescriptions, medical outcomes, genomic fingerprint, geolocation data, and other biometric data may be aggregated and utilized for clinical research via machine learning algorithms.

Relevant health data associated with a Digital Medical Identity Parent UIAM token may be aggregated and anonymized and provided to medical research pools as, for example, a health data utility NFT. In certain embodiments, certain Medical Identity Child UIAMs may be tokenized expressions of a patient's phenotypical traits, medical history, environment, medical treatments and regimens, prescriptions, diet, metabolic data, and/or the like. In some embodiments, it is contemplated that Medical Identity Child UIAMs may omit personal information that could be used to identify the patient.

A physician, medical professional, and/or medical practice may possess one or more Medical Professional Identity Tokens, which may be understood as specialized token would be a token that carries an individual's and/or corporate entity's credentials and licenses relating to medicine and wellness. It is contemplated that such tokens may be minted using the ERC 1155 token standard within UIAM Application Entity 120 and/or using API call to other verification nodes. In certain embodiments, Medical Professional Identity Tokens may be provisioned via whitelisting Identity Parent UIAM of the medical professionals. It is contemplated that Medical Professional Identity Token holders may prescribe and tokenize pharmaceuticals, therapeutics, an/or nutraceuticals to patients by transferring ownership of prescription UIAM tokens to patients. Medical Professional Identity Token holders may also be provided with patient data via, for example, the provision of medical identity Child UIAMs.

It is contemplated that certain Medical Professional Identity Tokens may be specific to area of expertise and/or scope of practice. Such tokens may govern data access. For example, while the holder of a Physician Medical Professional Identity Token may have broad access to patient data, a genetic interpreter Medical Professional Identity Token may only have access to a patient's genetic information and a Metabolic Interpreter Medical Professional Identity Token may only have access to a patient's metabolic information.

In some embodiments, the UIAM framework can substantially improve disease tracking. As a prescient, but non-limiting example, COVID-19 variants are being tracked and traced and analyzed by researchers to determine the location of new deadly outbreaks. Medical Identity Parent UIAM owners (regardless of vaccination status) may opt in to provide data to a COVID-19 tokenized liquidity pool and engage in data-driven self-discovery processes (which, in some embodiments may be open source of publicly available). The aggregated Parent UIAM data from the COVID-19 tokenized liquidity pool may serve to indicate which vaccines and other treatments may be most or least effective against various COVID-19 variant threats based on an individual's genes, locations, body condition, age, sex, habits, and/or the like. Such a rich diagnostic data set may be made available to researchers and the public alike to prevent infection, reduce infection-related harms, reduce infection spread, and derive new vaccines and treatments. By utilizing the UIAM framework, this rich data set may be reliably gathered in a pseudo-anonymous and HIPPA compliant way via surveys, and the gathering of raw data from individual's Parent UIAMs (including, e.g., environmental, biometric, genomic, metabolic, diet exercise, heart rate, a tokenized genome and the like). It is contemplated that processing this aggregated raw data may be processed via machine learning algorithms.

In some embodiments, a consumer token may additionally or alternatively enable the provision of genetic or health data of the consumer to UIAM Application Entity 120 such that product experience data may be linked with consumer product experience data—preferably in a manner than protects consumer privacy. In turn, the collection and correlation of consumer product experience data and consumer health/genetic data may facilitate the provision of personalized medicine and/or provide a rich data set that may support medical research, FDA or other regulatory body submissions, and/or the like. In one example, pooled data may be provided to researchers by UIAM system 100 related to specific areas of study and/or specific treatment modalities; this may support research and development relating to specific disease models. The provision of such rich data sets and/or reports derived therefrom may offer addition revenue streams, add to value proposition of UIAM system 100, and/or the like.

In yet another example of specialized tokens, a customer token may be provided to, for example, down-stream end users of a UIAM-linked asset (e.g., a consumer of the flower of a particular cannabis strain for which a clone was sold as a UIAM-linked asset). Such a token may enable an end user to provide feedback relating to their experience with the product, for example, via a consumer satisfaction survey (e.g., QualSCORE (www.qualscore.net) or the like) and/or other measures of product efficacy, safety, experience coherence, consumer preference, and/or the like. In some embodiments, certain of these measures may be automatically submitted (e.g., from a product delivery device that generates and records such data).

### UIAM Financial Identity Embodiments

A Financial Identity Parent UIAM may embody an individual's social security number, birth certificate, driver's license, passport, bank account numbers, an expression of individual's genetic fingerprint (e.g., a gene sequence file) in case verification is required, an individual's actual fingerprints, credentials and other certifications earned by the owner, other identifying personal information or documentation, and/or the like. In this manner, financial identity UIAMs may serve as a robust and verifiable form of identification for financial transactions, permissioned access to data, permissioned access to secured website, permissioned access to vaults, and the like, while reducing the risk of identity theft inherent in current system. It is contemplated that the owner of a financial identity Parent UIAM may generate financial identity Child UIAMs and transfer them to others' identity Parent UIAMs to effectuate financial transactions, enable access to proprietary data, and/or the like. In some embodiments, the owner of a financial identity Parent UIAM may generate, receive, or transfer asset-based Parent or Child UIAMs. In this manner, a financial identity Parent UIAM may link and individual to individual or grouped assets—regardless of whether such assets have physical embodiments or are entirely digital in nature.

### Liquidity Pools

In some embodiments, the UIAM framework may be utilized for investments toward, for example, achieving solutions to problems in a distributed manner. Such investment vehicle may be referred to herein as a liquidity pool.

In some embodiments, a liquidity pool may effectively operate as a tokenized hedge fund. In the medical context, such liquidity pools may be directed toward a disease-specific goal (e.g., curing COVID-19), but this disclosure is not so limited. Liquidity pools may be used for other diseases, conditions, groups thereof, and well as applications outside of the medical context. Each liquidity pool may be embodied by a Parent UIAM. Funders of such liquidity pools my utilize their own respective UIAMs and/or financial assets (e.g., UTs, cryptocurrency, and/or fiat currency) to both provide liquidity/funds to the Parent UIAM of the liquidity pool and maintain appropriate ownership in the liquidity pool, solution(s) derived, and profits therefrom.

Assets from the liquidity pools maybe spent and distributed to various participants who contribute to the solution(s) via, for example, smart contract and chain code. The distribution of liquidity pool assets may automatically proceed when certain conditions were met within the gamification and tokenization protocols of each particular liquidity pool. It some embodiments, it is contemplated that each liquidity pool may have a life cycle, and that participants would be rewarded and funds would be distributed proportionally upon completion and/or at various sub-completion points.

In one non-limiting example, health/medical trial participants (e.g., volunteers and/or patients) may receive rewards when significant advances in either the application of or advancement in therapeutics or new curatives are discovered. UIAM owners who participated in or provided, value, put in the work to solve, and/or made a significant or a quantifiable contribution may receive compensation. It is contemplated that, in some circumstances, at least a participants' gene sequence file and at least one other critical piece data (e.g., vaccination status for the COVID-19 virus) may be required to be reward eligible.

Utilizing blockchains as data storage methods and various consensus mechanisms and methods of governance, UIAM decentralized applications may serve as the core infrastructure and architecture to operate such tokenized liquidity pools, including for medical trials. Owners of individual identity Parent UIAMs may be permitted to opt in to participate in such trials. Researchers may be compensated from the liquidity pool (e.g., funded by the government, Universities, NGOs, for-profit companies, and/or as discussed above.) for proposing solutions, providing validated solutions, validating solutions, solving the problem, and/or making other contributions.

### Chain of Custody Monitoring Embodiments

In some embodiments, the UIAM framework may be utilized for tracking chain of custody through a supply chain, including to the end consumer. This may be of particular advantage where a controlled substance, a particularly valuable good, and/or dangerous good is produced and distributed.

With reference to FIG. 9, an embodiment of a UIAM supply chain monitoring method 900 is provided.

As in step 910, a Corporate Identity Parent UIAM Token may be minted. Such UIAM token may be considered a financial identity token. Such process may involve the creation of a Corporate Identity Parent UIAM File from corporate documents (e.g., articles of incorporation, an operating agreement, a list of membership certificate owners or shares); certificates, registrations, and/or licenses; corporate financial information and/or the like. The Corporate Identity Parent UIAM File may be tokenized and stored on a blockchain using processes substantially similar to those described above. In some embodiments, the ERC 998 Non fungible composable smart contract standard may be used.

As in step 920, the Employee Identity UIAM tokens may be minted. In one example, such Employee Identity UIAM tokens may be minted as children to the Corporate Identity Parent UIAM Token. It is contemplated that such Employee Identity UIAM tokens may be minted as part of the hiring process in some embodiments. Each Employee Identity UIAM file may include the employee's genome sequence file, actual fingerprint, photograph, government issued identification, social securing number and/or the like as identifiers. The Employee Identity UIAM File may be tokenized and stored on a blockchain using processes substantially similar to those described above. In some embodiments, the ERC 998 Non fungible composable smart contract standard may be used.

As in step 930, each employee's identity may be further validated by, for example, taking a video recording the employee collecting a genetic sample using a swab, and placing such sample into a securely locked biological specimen container. The container and/or the swab may be RFID tagged in certain embodiments. Additionally, the employee's geospatial coordinates at the time the swab was taken may be recorded; in some embodiments, such information may be published as an Oracle on a public blockchain.

As in step 940, Unit Child UIAM tokens of the Corporate Identity Parent UIAM Token may be minted for each unit of manufacture (which may be a single dose, other single item and/or batch of items). Ownership by the Corporate Identity Parent UIAM Token may be recorded on the public blockchain.

As in step 950, the units may be manufactured. A transaction linking each Unit Child UIAM token to the Employee Identity UIAM token of each employee involved with manufacture of the physical unit may be recorded on a public blockchain.

As in step 960, the manufactured units may be sent to a packaging line. A transaction linking each Unit Child UIAM token to the Employee Identity UIAM token of each employee involved with packaging of the physical unit may be recorded on a public blockchain.

As in step 970, the tokenized products are provided to a distributor. In embodiments where the products are controlled substances, for example, the distributor may be the holder of a Medical Professional Identity Token that authorizes possession and/or prescribing such drugs. A transaction may be recorded on a public blockchain indicating that the Identity Parent UIAM token owning the corresponding Medical Professional Identity Token is now in possession of the Unit Child UIAM token(s).

As in step 980, the tokenized products may be provided to the end user. In embodiments where the products are controlled substances, the Medical Professional Identity Token holder may prescribe appropriate doses to patients. A transaction may be recorded on a public blockchain indicating that a Patient Medical Identity Parent UIAM token is possession of the corresponding Unit Child UIAM token(s).

In sum, embodiments of method 900 utilize the UIAM framework to provide an immutable, auditable, reliable, and substantially fraud proof chain of custody.

### Additional Embodiments and Features

It is contemplated that, in some embodiments, permissioned access to certain aspects and data within UIAM System 100 may be provided via specialized tokens.

In one example of specialized tokens, a financial access token (e.g., a “FINCEN token”) may be provided to financial regulators and/or the like as to enable permissioned access to financial processes and/or records used, owned, or maintained by financial exchange entity 180. Use of such financial access tokens may, without undermining privacy and/or security, reduce the burdens of regulatory compliance and increase transparency with respect to financial regulations for both UIAM System 100 and regulators alike. In some embodiments, a financial access token may additionally or alternatively provide permissioned access to aspects of UIAM Application Entity 120 and/or public blockchain entity 160.

In another example of specialized tokens, a regulatory access token (e.g., a “cannabis compliance token”), may be provided to state, local, or federal regulators and/or the like. Such token may enable permissioned access to processes and/or records used, owned, or maintained by UIAM Application Entity 120 that are, for example, relevant to the sale of a highly regulated product (e.g., cannabis plant material). Such processes and records may include, but are not limited to the identity of customers and sellers, age data, licensing data, registration data, safety report data, and/or the like.

In some embodiments, APIs or ABIs (Application Blockchain Interface) that facilitate engagement with UIAM System 100 may be distributed to enable other entities within the stream of commerce and/or value chain to seamlessly integrate with UIAM system 100. For example, the provision of APIs or ABIs may enable increased, improved, or expanded sales /marketing channels; streamline regulatory/legal compliance; streamline receipt of consumer data; provide additional means to verify the identity of a UIAM-linked asset (e.g., via silica tags encoded by identifying patterns provided by Tag-It Tech (tagittech.com/)); and/or otherwise improve system 100, its capabilities, and its reach. Such APIs or ABIs may preferably interface with UIAM Application entity 120, but this disclosure is not so limited.

Although the foregoing embodiments have been described in detail by way of illustration and example for purposes of clarity of understanding, it will be readily apparent to those of ordinary skill in the art in light of the description herein that certain changes and modifications may be made thereto without departing from the spirit or scope of the disclosure. It is also to be understood that the terminology used herein is for the purpose of describing particular aspects only, and is not intended to be limiting, since the scope of the present invention will be limited only by claims.

It is noted that, as used herein, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of ordinary skill in the art upon reading this disclosure, each of the individual aspects described and illustrated herein has discrete components and features which may be readily separated from or combined with the features of any of the other several aspects without departing from the scope or spirit of the disclosure. Any recited method can be carried out in the order of events recited or in any other order that is logically possible. Accordingly, the preceding merely provides illustrative examples. It will be appreciated that those of ordinary skill in the art will be able to devise various arrangements which, although not explicitly described or shown herein, embody the principles of the disclosure and are included within its spirit and scope.

Furthermore, all examples and conditional language recited herein are principally intended to aid the reader in understanding the principles of the invention and the concepts contributed by the inventors to furthering the art, and are to be construed without limitation to such specifically recited examples and conditions. Moreover, all statements herein reciting principles and aspects of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary configurations shown and described herein.

In this specification, various preferred embodiments have been described with reference to the accompanying drawings. It will be apparent, however, that various other modifications and changes may be made thereto and additional embodiments may be implemented without departing from the broader scope of this disclosure. The specification and drawings are accordingly to be regarded in an illustrative rather than restrictive sense.

We claim:

1. A method of offering at least one Unique Identity Asset Marker (UIAM)-linked asset for sale, the method comprising:
receiving a request to mint a Parent UIAM token and at least one Child UIAM token from a verified seller with a UIAM minter account;
receiving, from the verified seller, a total number of the at least one UIAM-linked asset for sale and financial terms for sale of each of the at least one UIAM-linked asset for sale;
receiving, from the verified seller, a public-facing description of the at least one UIAM-linked asset for sale;
receiving, from the verified seller, proprietary data pertaining to the at least one UIAM-linked asset for sale;
compiling a Parent UIAM file based on verified seller input;
minting a Parent UIAM token on a first blockchain;
minting one Child UIAM token on the first blockchain for each of the total number of the at least one UIAM-linked asset for sale;
assigning ownership of the Parent UIAM token and each Child UIAM token to the verified seller;
loading the proprietary data into a database;
recording a permission structure for accessing the proprietary data in the first blockchain;
configuring the public facing description for public viewing; and
offering each Child UIAM token and its associated UIAM-linked asset for sale.

2. The method of claim 1, further comprising:
receiving utility tokens from the verified seller as compensation for UIAM token minting.

3. The method of claim 1, further comprising:
receiving stable bank coins from the verified seller as compensation for UIAM minting.

4. The method of claim 1, wherein the at least one UIAM-linked asset for sale is a genomic asset.

5. The method of claim 4, wherein the step of receiving, from the verified seller, proprietary data pertaining to the at least one UIAM-linked asset for sale further comprises:
receiving a gene sequence file of the genomic asset.

6. The method of claim 4, wherein:
the genomic asset comprises at least one of a cannabis plant, seed, flower, and a derivative thereof; and
the step of receiving, from the verified seller, the public-facing description of the at least one UIAM-linked asset for sale further comprises receiving a cultivar name from the verified seller.

7. The method of claim 6, wherein the step of receiving, from the verified seller, proprietary data pertaining to the at least one UIAM-linked asset for sale further comprises:
receiving a gene sequence file of the genomic asset.

8. The method of claim 6, wherein the step of receiving, from the verified seller, proprietary data pertaining to the at least one UIAM-linked asset for sale further comprises:
receiving phenotypical trait data relating to a particular environmental condition.

9. The method of claim 4, wherein the step of receiving, from the verified seller, the public-facing description of the at least one UIAM-linked asset for sale further comprises:
receiving a gene sequence file of the genomic asset.

10. The method of claim 4, further comprising:
receiving from the verified seller Ricardian Contract terms governing a contemplated sale of the at least one UIAM-linked asset.

11. The method of claim 4, wherein the step of receiving, from the verified seller, the public-facing description of the at least one UIAM-linked asset for sale further comprises:
receiving a description of downstream breeding rights governing the genomic asset.

12. The method of claim 11, further comprising:
Receiving, from the verified seller, Ricardian Contract terms governing a contemplated sale of the at least one UIAM-linked asset, wherein at least a portion of the Ricardian Contract terms address downstream breeding rights.

13. The method of claim 1, wherein the step of configuring the public facing description for public viewing further comprises:
loading at least a portion of the public facing description into an InterPlanetary File System.

14. The method of claim 1, wherein the step of configuring the public facing description for public viewing further comprises:
publishing at least a portion of the public facing description as an Oracle on the first blockchain.

15. The method of claim 1, wherein the step of loading the proprietary data into a database further comprises:
loading at least a portion of the proprietary data into an InterPlanetary File System.

16. The method of claim 1, wherein the step of receiving, from the verified seller a total number of the at least one UIAM-linked asset for sale and financial terms for sale of each of the at least one UIAM-linked asset for sale further comprises:
providing the verified seller with selectable smart contract options; and
receiving selections of smart contract options from the verified seller.

17. The method of claim 1, wherein the step of receiving, from the verified seller, the public-facing description of the at least one UIAM-linked asset for sale further comprises at least one of:
receiving directly uploaded data files from the seller;
receiving an Internet address; and
receiving references to a UIAM token.

18. The method of claim 1, wherein the step of receiving, from the verified seller, proprietary data pertaining to the at least one UIAM-linked asset for sale further comprises at least one of:
receiving directly uploaded data files from the seller;
receiving an Internet address; and
receiving references to a UIAM token.

19. The method of claim 1, further comprising receiving, from a prospective seller, financial account data;
receiving, from a prospective seller, identifying information;
verifying the data provided by the prospective seller;
if the data verification is successful, whitelisting a digital wallet of the prospective seller via smart contract execution on the first blockchain;
and generating a UIAM minter account for the seller.

20. The method of claim 1, further comprising:
receiving, from a prospective seller, financial account data;
receiving, from a prospective seller, identifying information;
verifying the data provided by the prospective seller;
if the data verification is successful, generating a UIAM minter account for the verified seller;
recording the verified seller identity and minter status in the first blockchain; and
and providing a UIAM minter token and an identity token to the verified seller.
